(19) United States
(12) Patent Application Publication
(10) Pub. No.: US 2013/0208496 A1
(43) Pub. Date: Aug. 15, 2013

(54) ILLUMINATING DEVICE

(71) Applicant: Sharp Kabushiki Kaisha, (US)

(72) Inventor: Katsuhiko Kishimoto, Osaka-shi (JP)

(73) Assignee: SHARP KABUSHIKI KAISHA, Osaka (JP)

(21) Appl. No.: 13/752,617

(22) Filed: Jan. 29, 2013

(30) Foreign Application Priority Data
Jan. 31, 2012 (JP) 2012-017770
Jan. 31, 2012 (JP) 2012-017771
Jan. 31, 2012 (JP) 2012-017772

(51) Int. Cl. F21V 9/16; F21V 8/00

(52) U.S. Cl. CPC F21V 9/16; G02B 6/0008; F21S 48/10
USPC 362/553; 362/509; 362/84

(57) ABSTRACT

An illuminating device capable of improving eye-friendliness is provided. The illuminating device includes a fluorescent member that is irradiated with laser light functioning as excitation light to emit fluorescence, a condensation sensor that detects condensation near an optical path of the laser light, and a controller that limits irradiation of the laser light onto the fluorescent member in a case where the condensation sensor has detected condensation.

This application is based on Japanese Patent Applications No. 2012-017772, No. 2012-017770, and No. 2012-017771 filed on Jan. 31, 2012, the contents of which are hereby incorporated by reference.

### BACKGROUND OF THE INVENTION

1. Field of the Invention

The present invention relates to an illuminating device, and in particular, the present invention relates to an illuminating device incorporating a fluorescent member that is irradiated with laser light functioning as excitation light.

2. Description of Related Art

There has conventionally been known an illuminating device provided with a fluorescent member to be irradiated with laser light functioning as excitation light. A known example of such an illuminating device is a vehicle headlamp (an illuminating device) provided with a semiconductor laser (an excitation light source) that emits laser light as excitation light, a fluorescent member that emits fluorescence on being irradiated with the laser light, a reflection mirror (a reflection member) that outwardly reflects the fluorescence, and a transmissive member through which fluorescence passes to be outwardly emitted therefrom. The laser light emitted from the semiconductor laser is converted by the fluorescent member into fluorescence and passes through the transmissive member, to be used as illumination light.

For example, JP-A-2004-241142 and JP-A-2005-150041 disclose examples of an illuminating device provided with an excitation light source that emits laser light and a fluorescent member that is irradiated with the laser light.

However, after various considerations and reviews on the conventional illuminating devices described above, the inventor of the present invention has found that there are cases where condensation forms inside a conventional illuminating device, such cases including cases where the condensation causes laser light to deviate from a defined beam path. According to the definition by JIS C6802, the defined beam path is an optical path of a laser beam along which the laser beam is designed to travel inside a laser product.

A specific description will be given in this regard. Air having a higher temperature is able to hold more water vapor. When the temperature of the air falls, part of the water vapor can no longer be held in the air, and such part of the water vapor is condensed into water droplets to stick to a surface of an object having a low temperature. This phenomenon is called condensation. In the present specification and claims, water droplets resulting from condensation may also be called as condensation.

For example, in the above conventional illuminating devices, when the fluorescent member is irradiated with laser light, a temperature of and around the fluorescent member rises, causing a rise in temperature of a space surrounded by the reflection mirror, the transmissive member, etc. The air in this space is now able to hold more water vapor than before the rise of its temperature.

Then, when the illuminating device is turned off, the temperature of and around the fluorescent member drops, causing a drop in the temperature of the space surrounded by the reflection mirror and the transmissive member. As a result, condensation occurs inside the space. In this case, condensation would exist inside the space when the illuminating device is turned on next time and laser light is emitted toward the fluorescent member. If condensation forms in the defined beam path (for example, on a surface of the fluorescent member), the laser light may be reflected or refracted by water droplets and deviated from the defined beam path.

Such deviation of the laser light is disadvantageous, because it may result in a case where the laser light leaks outside to exert harmful effects on human eyes.

The inventor has found no literature of prior art that addresses the problem where laser light is caused to deviate from the defined beam path by condensation formed in an illuminating device that is designed to obtain illumination light by irradiating a fluorescent member with laser light.

### SUMMARY OF THE INVENTION

The present invention has been made to solve the above problem, and an object of the present invention is to provide an illuminating device capable of improving eye-friendliness.

Another object of the present invention is to provide an illuminating device capable of reducing deviation of laser light from a defined beam path.

To achieve the above objects, according to one aspect of the present invention, an illuminating device includes a fluorescent member that is irradiated with laser light functioning as excitation light to emit fluorescence, a condensation sensor that detects condensation near an optical path of the laser light, and a controller that limits irradiation of the laser light onto the fluorescent member in a case where the condensation sensor has detected condensation.

In the present specification and claims, the concept of detecting condensation near the optical path of the laser light includes detecting condensation in the optical path of the laser light. Besides, the concept of limiting the irradiation of laser light onto the fluorescent member includes lowering the power of the excitation light source to a level safe to human eyes, blocking or changing the optical path of the laser light to prevent leakage of the laser light out of the illuminating device, etc.

The illuminating device of the present invention, as described above, includes the condensation sensor that detects condensation near the optical path of the laser light, and the controller that limits irradiation of the laser light onto the fluorescent member in a case where the condensation sensor has detected condensation. Thereby, it is possible for the controller to limit the irradiation of the laser light onto the fluorescent member, and this makes it possible to reduce reflection or refraction of the laser light caused by water droplets. Thus, it is possible to reduce leakage of the laser light having such high power that it exerts harmful effects on human eyes. This helps make the illuminating device more eye-friendly.

In the illuminating device described above, it is preferable that the controller control power of an excitation light source that emits the laser light to be equal to or lower than a predetermined level. With this configuration, it is possible to easily reduce leakage of the laser light out of the illuminating device, the laser light having such high power that it exerts harmful effects on human eyes.

In this case, it is preferable that the controller control the power of the excitation light source to be zero. With this configuration, it is possible to securely prevent the laser light from exerting harmful effects on human eyes in a case where the condensation sensor has detected condensation.

In the above-described illuminating device, it is preferable that the controller block or change the optical path of the laser light. With this configuration, it is possible to easily reduce leakage of the laser light out of the illuminating device, the laser light having such high power that it exerts harmful effects on human eyes.

It is preferable that the above illuminating device where the controller blocks or changes the optical path of the laser light further include a light-blocking member that blocks the optical path of the laser light, and that the controller insert the light-blocking member into the optical path of the laser light. With this configuration, it is possible to easily block the optical path of the laser light.

It is preferable that the above illuminating device where the controller blocks or changes the optical path of the laser light further include an optical path changing member that changes the optical path of the laser light, and that the controller change a position or an angle of the optical path changing member. With this configuration, by moving the optical path changing member into the optical path of the laser light, or by changing the angle of the optical path changing member in a case where the optical path changing member is already disposed in the optical path of the laser light, it is possible to easily change the optical path of the laser light.

It is preferable that the above illuminating device provided with the optical path changing member further include a beam stop disposed so as to be in the optical path of the laser light when the optical path is changed by the optical path changing member. The beam stop is, according to the definition by JIS C6802, a device that terminates an optical path of a laser beam.

In the illuminating device described above, it is preferable that the condensation sensor have a function of measuring at least one of electric resistance and relative humidity. With this configuration, it is possible to easily detect condensation by means of the condensation sensor. Note that, in the present specification and the claims, measuring the relative humidity includes a case where absolute humidity and temperature (air temperature) are measured and then the relative humidity is calculated based on the measured absolute humidity and temperature.

It is preferable that the illuminating device described above further include a body inside which the fluorescent member is disposed, and that the condensation sensor detect condensation inside the body. With this configuration, it is possible to detect condensation near the fluorescent member, and this is particularly advantageous.

It is preferable that the illuminating device described above further include a condensation removing unit that removes condensation on a laser-light-passing surface of a member disposed in the optical path of the laser light. With this configuration, it is possible to obtain desired illumination light by releasing the limitation on the irradiation of the laser light onto the fluorescent member after the condensation on the laser-light-passing surface is removed by the condensation removing unit.

Note that, in the present specification and claims, a laser-light-passing surface means a surface through which the laser light passes, and it is a concept that includes, for example, the laser-light-exit surface of the excitation light source, the laser-light-entrance surface and the laser-light-exit surface of the light guide member, the irradiated surface of the fluorescent member that is irradiated with the laser light, and the like. Besides, to remove condensation means to remove water droplets resulting from condensation.

In the above illuminating device provided with the condensation removing unit, it is preferable that the condensation removing unit include a heater for heating the laser-light-passing surface. With this configuration, it is possible to easily remove condensation on the laser-light-passing surface.

It is preferable that the above illuminating device provided with the condensation removing unit further include a light guide member that guides the laser light emitted from the excitation light source to the fluorescent member. With this configuration, it is possible to easily guide the laser light emitted from the excitation light source to the fluorescent member.

In the above illuminating device provided with the light guide member, it is preferable that the condensation removing unit remove condensation on the laser-light-passing surface of the light guide member.

In the above case, it is preferable that the condensation removing unit include a heater for heating the laser-light-passing surface, that the laser-light-passing surface include the laser-light-exit surface of the light guide member, and that a heat conductive portion that transfers heat generated by the heater to the laser-light-exit surface of the light guide member be provided on a surface of the light guide member. By the condensation removing unit including the heater for heating the laser-light-passing surface in this way, it is possible to easily remove condensation on the laser-light-passing surface. And, by providing the surface of the light guide member with the heat conductive portion that transfers heat generated by the heater to the laser-light-exit surface of the light guide member, it is possible to easily transfer the heat generated by the heater to the laser-light-exit surface of the light guide member. Thereby, it is possible to remove condensation on the laser-light-passing surface (laser-light-exit surface) more easily.

In the above illuminating device provided with the condensation removing unit, it is preferable that the condensation removing unit remove condensation on an irradiated surface of the fluorescent member that is irradiated with the laser light.

According to another aspect of the present invention, an illuminating device includes a fluorescent member that is irradiated with laser light functioning as excitation light to emit fluorescence, and a body constituting a hermetic space inside which the fluorescent member is disposed. Here, a dry gas is sealed in the hermetic space, or the hermetic space is a vacuum space.

Note that, in the present specification and claims, to be hermetic means to be sealed to be impervious to gas, and a hermetic space means a space that is sealed to be impervious to gas.

The above illuminating device of the present invention is, as described above, provided with the body constituting a hermetic space inside which the fluorescent member is disposed, and a dry gas is sealed in the hermetic space, or the hermetic space is a vacuum space. Thus, it is possible to prevent condensation in the hermetic space, and thus, it is possible to prevent water droplets from sticking to the surface of, for example, the fluorescent member. This helps reduce deviation of the laser light from the defined beam path resulting from the laser light being reflected or refracted by such water droplets. As a result, it is possible to reduce cases where desired illumination light fails to be obtained or cases where leaked laser light exerts harmful effects on human eyes.

In addition, by disposing the fluorescent member inside the hermetic space, it is possible to reduce degradation of the fluorescent member caused, for example, by moisture.

In the illuminating device described above, it is preferable that a dry gas be sealed in the hermetic space, and that the dry gas contain dry air or an inert gas. If the dry gas contains dry air or an inert gas in this way, it is possible to easily prevent condensation inside the hermetic space. In addition, in the case where a dry gas is sealed in the hermetic space, the hermetic space is not a vacuum space, and this helps prevent the body from being crushed by the pressure from ambient air.

In the illuminating device described above, it is preferable that the body include a reflection member that reflects the fluorescence, and a first transmissive member that transmits the fluorescence and emits the fluorescence to outside the hermetic space. With this configuration, it is possible to reflect the fluorescence emitted from the fluorescent member by the reflection member in a predetermined direction, and this makes it possible to easily illuminate a predetermined area.

In the illuminating device described above, it is preferable that a dew point inside the hermetic space be equal to or lower than −30° C. For example, among areas where the above illuminating device is assumed to be used, an area between 50° North latitude and 50° South latitude, the annual minimum temperature is very rarely below −30° C. Thus, the dew point of −30° C. or lower is sufficient to prevent condensation inside the hermetic space.

In the illuminating device described above, it is preferable that the excitation light source that emits the laser light functioning as the excitation light be disposed outside the hermetic space, and that the body be provided with an inlet for allowing the laser light emitted from the excitation light source into the hermetic space. With this configuration, in the case where the excitation light source is disposed outside the hermetic space, it is possible to easily allow the laser light emitted from the excitation light source into the hermetic space.

In the above illuminating device where the body is provided with the inlet, it is preferable that the illuminating device further include a light guide member that guides the laser light emitted from the excitation light source to the fluorescent member. With this configuration, it is possible to easily allow the laser light emitted from the excitation light source into the hermetic space.

In the above illuminating device provided with the light guide member, it is preferable that the light guide member be put through the inlet without a gap therebetween. With this configuration, it is possible to insert the light guide member into the hermetic space while maintaining the hermeticity of the hermetic space, and to easily allow the laser light emitted from the excitation light source into the hermetic space.

In the above illuminating device where the body is provided with the inlet, it is preferable that the inlet be provided with a second transmissive member that transmits the laser light and that is attached to the inlet without a gap therebetween. With this configuration, it is possible to easily allow the laser light emitted from the excitation light source into the hermetic space while maintaining the hermeticity of the hermetic space.

In the above illuminating device where the body is provided with the inlet, it is preferable that an optical path of the laser light from the excitation light source to the inlet be sealed.

In the illuminating device described above, it is preferable that the excitation light source that emits the laser light functioning as the excitation light be disposed inside the hermetic space. With this configuration, it is possible to prevent condensation all over the defined beam path, and thus, it is possible to prevent the laser light from deviating from the defined beam path.

According to another aspect of the present invention, an illuminating device includes a fluorescent member that is irradiated with laser light functioning as excitation light to emit fluorescence, and a first anti-condensation unit that performs a preliminary operation of removing or preventing condensation on a laser-light-passing surface of a member disposed in an optical path of the laser light, the operation being performed before a principal operation of an excitation light source.

Note that, in the present specification and claims, the principal operation of the excitation light source means an operation in which the excitation light source emits laser light to obtain desired illumination light. Note that a laser-light-passing surface means a surface through which the laser light passes, and it is a concept including, for example, the laser-light-exit surface of the excitation light source, the laser-light-entrance surface and the laser-light-exit surface of the light guide member, the irradiated surface of the fluorescent member that is irradiated with laser light, and the like. Also, to remove or prevent condensation means to remove water droplets resulting from condensation or prevent water droplets from being formed by condensation.

The above illuminating device of the present invention is, as described above, provided with the first anti-condensation unit that performs, before the excitation light source performs the principal operation thereof, the preliminary operation of removing or preventing condensation on the laser-light-passing surface of the member disposed in the optical path of the laser light. Thereby, it is possible to make the excitation light source perform the principal operation after the preliminary operation is performed to remove or prevent condensation on the laser-light-passing surface. This helps reduce deviation of the laser light from the defined beam path caused by reflection or refraction of the laser light by water droplets. As a result, it is possible to reduce cases where desired illumination light fails to be obtained or cases where leaked laser light exerts harmful effects on human eyes.

In the illuminating device described above, it is preferable that the first anti-condensation unit include a heater for heating the laser-light-passing surface. With this configuration, it is possible to easily remove or prevent condensation on the laser-light-passing surface.

It is preferable that the illuminating device described above further include a light guide member that guide the laser light emitted from the excitation light source to the fluorescent member. With this configuration, it is possible to easily guide the laser light emitted from the excitation light source to the fluorescent member.

In the illuminating device described above, it is preferable that the preliminary operation of the first anti-condensation unit include removing or preventing condensation on a laser-light-passing surface of the light guide member. With this configuration, it is possible to reduce deviation of laser light from the defined beam path before the laser light reaches the fluorescent member, and this is particularly advantageous.

In this case, it is preferable that the first anti-condensation unit include a heater for heating the laser-light-passing surface, that the laser-light-passing surface include a laser-light-exit surface of the light guide member, and that a heat conductive portion that transfers heat generated by the heater to the laser-light-exit surface of the light guide member be provided on a surface of the light guide member. Since the first anti-condensation unit includes the heater for heating the laser-light-passing surface in this way, it is possible to easily remove or prevent condensation on the laser-light-passing surface. And, by providing the surface of the light guide member with the heat conductive portion that transfers heat generated by the heater to the laser-light-exit surface of the light guide member, it is possible to easily transfer the heat generated by the heater to the laser-light-exit surface of the light guide member. Thereby, it is possible to remove or prevent condensation on the laser-light-passing surface more easily.

In the illuminating device described above, it is preferable that the preliminary operation of the first anti-condensation unit include removing or preventing condensation on an irradiated surface of the fluorescent member that is irradiated with the laser light. With this configuration, it is possible to reduce deviation of the laser light from the defined beam path caused by reflection of the laser light by water droplets on the irradiated surface of the fluorescent member.

In the illuminating device described above, it is preferable that the illuminating device further include a reflection member that reflects fluorescence. With this configuration, it is possible to reflect the fluorescence emitted from the fluorescent member by the reflection member in a predetermined direction, and this makes it possible to easily illuminate a predetermined area.

It is preferable that the illuminating device described above further include a body inside which the fluorescent member is disposed, that the excitation light source be disposed outside the body, and that the body include an inlet for allowing the laser light emitted from the excitation light source into the body. With this configuration, in a case where the excitation light source is disposed outside the body, it is possible to easily allow the laser light emitted from the excitation light source into the body.

In the above illuminating device provided with the inlet, it is preferable that the inlet be provided with a third transmissive member that transmits the laser light. Thereby, it is possible to prevent entry of dust or the like into the body through the inlet. This makes it possible to reduce deviation of the laser light from the defined beam path caused by the laser light hitting dust or the like.

In the above illuminating device provided with the third transmissive member, it is preferable that the preliminary operation of the first anti-condensation unit include removing or preventing condensation on a laser-light-passing surface of the third transmissive member. With this configuration, it is possible to reduce deviation of the laser light from the defined beam path before it reaches the fluorescent member, and this is particularly advantageous.

In the above illuminating device where the first anti-condensation unit includes the heater, it is preferable that the heater perform the preliminary operation for a predetermined length of time. With this configuration, it is possible to easily remove condensation on the laser-light-passing surface, for example.

In the above illuminating device where the first anti-condensation unit includes the heater, it is preferable that the heater continue the preliminary operation until a temperature around the laser-light-passing surface reaches a predetermined temperature. With this configuration, it is possible, for example, to easily remove condensation on the laser-light-passing surface.

In the above illuminating device where the first anti-condensation unit includes the heater, it is preferable that the heater continue the preliminary operation until a temperature around the laser-light-passing surface reaches a temperature that is higher than an outside air temperature by a predetermined value. With this configuration, it is possible to easily remove condensation on the laser-light-passing surface, for example.

In the above illuminating device where the first anti-condensation unit includes the heater, it is preferable that the excitation light source serve also as the heater, and that the power of the excitation light source be lower in the preliminary operation than in the principal operation. Thus, since the excitation light source serves also as the heater, there is no need of separately providing a heater, and this helps reduce the number of components and make the illuminating device compact. In addition, since the power of the excitation light source is lower in the preliminary operation than in the principal operation, it is possible to prevent high-power laser light from leaking out of the illuminating device while the preliminary operation is performed by using the excitation light source.

In the illuminating device described above, it is preferable that the illuminating device further include a reflection member having a reflection surface that reflects the fluorescence, and a second anti-condensation unit that performs an operation of removing or preventing condensation on the reflection surface. With this configuration, it is possible to prevent the fluorescence from being reflected or refracted by water droplets on the reflection surface, and this helps reduce cases where the desired illumination light is not able to be obtained.

In the illuminating device described above, it is preferable that the illuminating device further include a fourth transmissive member that transmits the fluorescence and emits the fluorescence to outside the illuminating device, and a second anti-condensation unit that performs an operation of removing or preventing condensation on a surface of the fourth transmissive member. With this configuration, it is possible to prevent the fluorescence from being reflected or refracted by water droplets on the surface of the fourth transmissive member, and thus to reduce cases where the desired illumination light is not able to be obtained.

In the illuminating device described above, it is preferable that the illuminating device be used as a vehicle headlamp, and that the preliminary operation of the first anti-condensation unit be started in association with at least one of the following: door locking, door unlocking, and door opening/closing. With this configuration, it is possible to remove or prevent condensation before a driver turns on the illuminating device, and this is particularly advantageous.

### BRIEF DESCRIPTION OF THE DRAWINGS

FIG. 1 is a sectional view showing a structure of an illuminating device of a first embodiment of the present invention;

FIG. 2 is a sectional view showing a structure of an illuminating device of a second embodiment of the present invention;

FIG. 3 is an enlarged sectional view showing a structure around a heat conductive layer of the second embodiment of the present invention shown in FIG. 2;

FIG. 4 is a sectional view showing a structure of an illuminating device of a third embodiment of the present invention;

FIG. 5 is a sectional view showing a structure of an illuminating device of a fourth embodiment of the present invention;

FIG. 6 is a sectional view showing a structure of an illuminating device of a fifth embodiment of the present invention;

FIG. 7 is a sectional view showing a structure of an illuminating device of a sixth embodiment of the present invention;

FIG. 8 is an enlarged sectional view for illustrating a structure of a condensation sensor of an illuminating device of a seventh embodiment of the present invention;

FIG. 9 is an enlarged view for illustrating a structure of a condensation sensor of an illuminating device of an eighth embodiment of the present invention;

FIG. 10 is a sectional view showing a structure of an illuminating device of a ninth embodiment of the present invention;

FIG. 11 is a sectional view showing the illuminating device of the ninth embodiment of the present invention shown in FIG. 10, showing a state where a light-blocking member is inserted in an optical path of laser light;

FIG. 12 is a sectional view showing a structure of an illuminating device of a tenth embodiment of the present invention;

FIG. 13 is a sectional view showing the illuminating device of the tenth embodiment of the present invention shown in FIG. 12, showing a state where the angle of an optical path changing member is changed to change the optical path of the laser light;

FIG. 14 is a sectional view showing a structure of an illuminating device of a first modified example of the present invention;

FIG. 15 is a sectional view showing a structure of an illuminating device of a second modified example of the present invention;

FIG. 16 is a sectional view showing a structure of an illuminating device of a third modified example of the present invention;

FIG. 17 is a sectional view showing a structure of an illuminating device of a fourth modified example of the present invention;

FIG. 18 is a sectional view showing a structure of an illuminating device of an eleventh embodiment of the present invention;

FIG. 19 is a sectional view showing a structure of an illuminating device of a twelfth embodiment of the present invention;

FIG. 20 is a sectional view showing a structure of an illuminating device of a thirteenth embodiment of the present invention;

FIG. 21 is a sectional view showing a structure of an illuminating device of a fifth modified example of the present invention;

FIG. 22 is a sectional view showing a structure of an illuminating device of a sixth modified example of the present invention;

FIG. 23 is a sectional view showing a structure of an illuminating device of a fourteenth embodiment of the present invention;

FIG. 24 is an enlarged sectional view showing a structure around a heat conductive layer of the fourteenth embodiment of the present invention shown in FIG. 23;

FIG. 25 is a sectional view showing a structure of an illuminating device of a fifteenth embodiment of the present invention;

FIG. 26 is a sectional view showing a structure of an illuminating device of a sixteenth embodiment of the present invention;

FIG. 27 is a sectional view showing a structure of an illuminating device of a seventeenth embodiment of the present invention;

FIG. 28 is a sectional view showing a structure of an illuminating device of an eighteenth embodiment of the present invention;

FIG. 29 is a sectional view showing a structure of an illuminating device of a nineteenth embodiment of the present invention;

FIG. 30 is a sectional view showing a structure of an illuminating device of a twentieth embodiment of the present invention;

FIG. 31 is a sectional view showing a structure of an illuminating device of a seventh modified example of the present invention; and

FIG. 32 is a sectional view showing a structure of an illuminating device of a eighth modified example of the present invention.

### DETAILED DESCRIPTION OF PREFERRED EMBODIMENTS

Embodiments of the present invention will be described below with reference to the accompanying drawings. In the sectional views, some sections are not indicated by hatching for easy understanding.

### First Embodiment

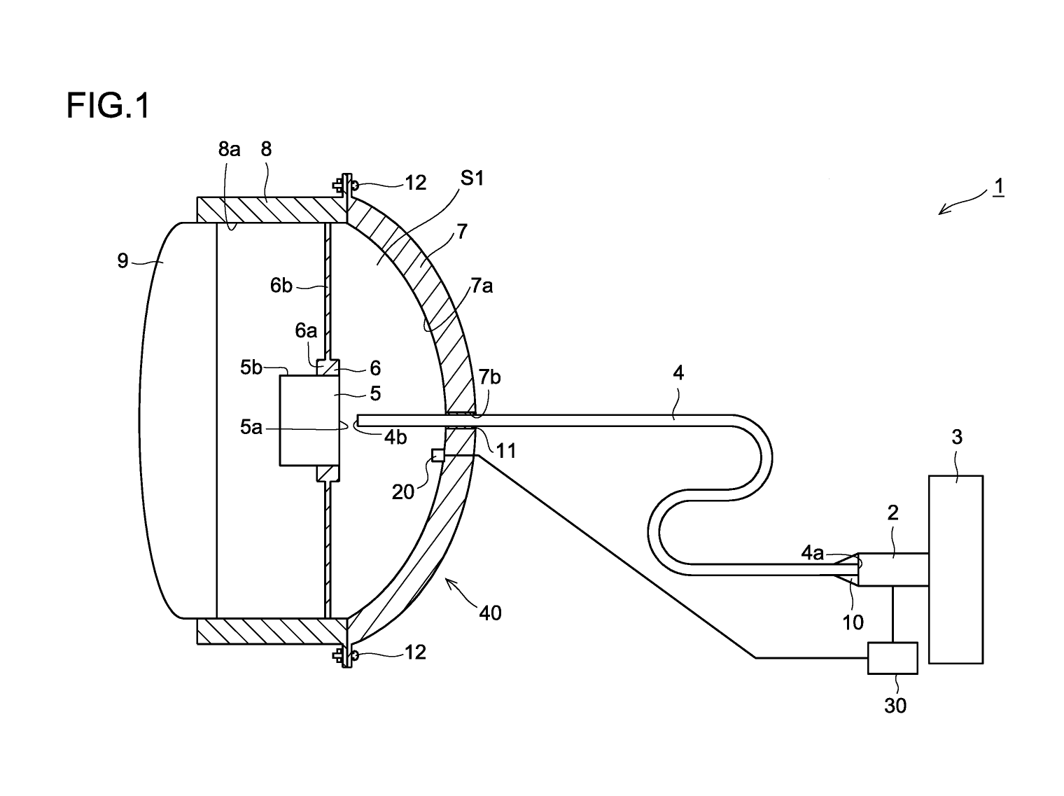

A description will be given of a structure of an illuminating device 1 of a first embodiment of the present invention with reference to FIG. 1.

The illuminating device 1 of the first embodiment of the present invention is one that is used as a headlamp that illuminates an area ahead of, for example, an automobile. As shown in FIG. 1, the illuminating device 1 includes an excitation light source 2 that emits laser light functioning as excitation light, a heat dissipation member 3 to which the excitation light source 2 is fixed, a light guide member 4 disposed anterior to the excitation light source 2, a fluorescent member 5 that is irradiated with laser light (the excitation light), a support member 6 that supports the fluorescent member 5, a reflection member 7 that reflects fluorescence, which is emitted from the fluorescent member 5, toward outside of a body 40 which will be described later, a bezel 8 that is fixed to a front edge of the reflection member 7, a transmissive member 9 that transmits the fluorescence and emits the fluorescence to outside the body 40, a condensation sensor 20 that detects condensation inside the later-described body 40 (condensation in a space S1 which will be described later), and a controller 30 that limits irradiation of the laser light onto the fluorescent member 5.

In the present embodiment, the body 40 is composed of the reflection member 7, the bezel 8, the transmissive member 9, and the like. The space S1 is inside the body 40. The space S1 may be hermetic, although it does not have to be hermetic. In the present specification, to be hermetic means to be sealed to be impervious to gas.

The excitation light source 2 is a semiconductor laser, and configured with a semiconductor laser element (not shown) and a package in which the semiconductor laser element is mounted. The excitation light source 2 is configured such that it emits laser light having, for example, a center wavelength of approximately 380 nm to approximately 460 nm. The excitation light source 2 is disposed outside the body 40.

The heat dissipation member 3 is formed of, for example, a metal block, and has a function of dissipating heat generated in the excitation light source 2. The heat dissipation member 3 is provided as necessary, and one of the existing members may be used as a substitute for the heat dissipation member 3.

The light guide member 4 has a function of guiding the laser light emitted from the excitation light source 2 to the fluorescent member 5. In the present embodiment, the light guide member 4 is formed of, for example, an optical fiber.

A laser-light-entrance surface 4a side part of the light guide member 4 is fixed to the excitation light source 2. A fixation member 10 is provided in such a manner that the fixation member 10 seals the laser-light-entrance surface 4a of the light guide member 4 and a laser-light-exit surface of the excitation light source 2. A connection portion between the light guide member 4 and the excitation light source 2 is formed such that no condensation is allowed to occur in the optical path of the laser light. For example, a transparent fixation member 10 may be provided between the laser-light-entrance surface 4a of the light guide member 4 and the laser-light-exit surface of the excitation light source 2. The light guide member 4 may be a pigtail fiber and the light guide member 4 may be pigtail-connected to the excitation light source 2. In this case as well, it is possible for the laser-light-entrance surface 4a of the light guide member 4 and the laser-light-exit surface of the excitation light source 2 to be hermetic, and to prevent condensation in the optical path of the laser light in the connection portion between the light guide member 4 and the excitation light source 2.

The laser-light-exit surface 4b side part of the light guide member 4 is put through a later-described inlet 7b of the reflection member 7 without a gap therebetween. For example, a seal member 11 is provided between an external surface of the light guide member 4 and an internal surface of the inlet 7b of the reflection member 7. The seal member 11 is not indispensable. The laser-light-exit surface 4b of the light guide member 4 is located inside the body 40.

The laser-light-exit surface 4b is disposed a predetermined distance away from an irradiated surface 5a of the fluorescent member 5, and the irradiated surface 5a is irradiated with the laser light. Thereby, it is possible to reduce re-entrance of light emitted from the irradiated surface 5a of the fluorescent member 5 into the light guide member 4 through the laser-light-exit surface 4b. This makes it possible to reduce degradation of light usage efficiency.

The fluorescent member 5 is disposed inside the body 40, and has a function of emitting fluorescence by being irradiated with the laser light (the excitation light). In addition, the fluorescent member 5 emits fluorescence having a center wavelength that is longer than the wavelength of the excitation light. The fluorescent member 5 includes, for example, three kinds of fluorescent substances (not shown) that convert blue-violet laser light into red light, green light, and blue light, respectively. The red light, the green light, and the blue light emitted from the fluorescent member 5 are mixed together, and thereby, white illumination light is obtained. Note that the fluorescent member 5 may include just one kind of fluorescent substance that converts, for example, part of blue laser light into yellow light. And, white illumination light may be obtained by mixing the yellow light with the blue light scattered by the fluorescent member 5. The fluorescent member 5 may be, for example, one that is made by mixing a fluorescent substance with glass, resin, etc. and forming the mixture into a lump, or one that is made by applying pressure to, or sintering, fluorescent particles.

The support member 6 includes a holding portion 6a that holds a side surface 5b of the fluorescent member 5 and a plurality of rod-shaped fitting portions 6b that are fitted to the bezel 8. The holding portion 6a may hold the side surface of the fluorescent member 5 directly or indirectly via, for example, a bonding layer. The fitting portions 6b may be fitted to the reflection member 7.

Further, the support member 6 is formed of a highly heat conductive material such as metal, graphite, etc. The support member 6 is configured such that it dissipates heat generated at the fluorescent member 5 to the bezel 8, the reflection member 7, an unillustrated metal block, etc.

The reflection member 7 has a function of outwardly reflecting light (for example, fluorescence, scattered light) emitted from the fluorescent member 5. A reflection surface 7a of the reflection member 7 is shaped concave such that the reflection surface 7a includes, for example, a part of a paraboloid. The irradiated surface 5a of the fluorescent member 5 is located in an area that includes a focal point of the reflection surface 7a. At a predetermined position in the reflection member 7 (for example, at a vertex thereof), the inlet 7b is provided for allowing the laser light (the excitation light) emitted from the excitation light source 2 into the body 40. The reflection member 7 is formed of metal, resin, etc. In a case where the reflection member 7 is formed of resin, the reflection surface 7a may be formed of, for example, a metal film.

The bezel 8 is formed for example in a cylindrical shape, and fixed to the front edge of the reflection member 7 with bolts 12, screws (not shown), etc. The bezel 8 is formed of metal, resin, etc. It is preferable that an internal surface 8a of the bezel 8 is formed as a reflection surface that has a function of reflecting light.

The transmissive member 9 is formed of a lens (for example, a planoconvex lens) made of glass, resin, etc. The transmissive member 9 is fixed to the internal surface 8a of the bezel 8. Between an external surface of the transmissive member 9 and the internal surface 8a of the bezel 8, there may be provided an unillustrated bonding member.

The condensation sensor 20 is disposed inside the body 40, and more specifically, for example, on the reflection surface 7a of the reflection member 7. The condensation sensor 20 detects condensation near the optical path of the laser light. It is preferable for the condensation sensor 20 to be disposed near the laser-light-exit surface 4b (a laser-light-passing surface) of the light guide member 4 or the irradiated surface 5a (a laser-light-passing surface) of the fluorescent member 5. With this configuration, it is possible to easily detect whether or not condensation has been formed on the laser-light-exit surface 4b of the light guide member 4 or on the irradiated surface 5a of the fluorescent member 5, without disposing the condensation sensor 20 on the laser-light-exit surface 4b of the light guide member 4 or on the irradiated surface 5a of the fluorescent member 5.

The condensation sensor 20 detects change in air humidity by means of, for example, change in electric resistance between conductive carbon particles dispersed within resin, and thereby detects condensation. In addition, the condensation sensor 20 may include a measurement portion that measures electric resistance and outputs a signal and a determination portion that determines, based on the output from the measurement portion, whether or not condensation has occurred. In this case, the measurement portion and the determination portion may be formed integrally or may be formed separately. It is also possible to incorporate the determination portion within the controller 30.

In the present embodiment, the controller 30 is connected to the condensation sensor 20 and the excitation light source 2. The controller 30 receives a signal that corresponds to whether or not the condensation sensor 20 has detected condensation. The controller 30 is configured such that it controls the power of the excitation light source 2 to be power for a normal condition (where no condensation has been formed) if the condensation sensor 20 has not detected condensation. The controller 30 is configured such that it controls the power of the excitation light source 2 to be equal to or lower than a predetermined value in a case where the condensation sensor 20 has detected condensation. Thereby, when the illuminating device 1 is turned on by a driver, it is possible to lower the power of the excitation light source 2 if condensation has been formed inside the body 40. Note that a value that is equal to or lower than a predetermined value means a value that does not allow the laser light to exert harmful effects on human eyes even if the laser light is reflected or refracted by water droplets to leak out of the illuminating device 1, and more specifically, the value is equal to or lower than one tenth of the power for the normal condition (where no condensation has been formed). The power of the excitation light source 2 when the condensation sensor 20 has detected condensation may be zero.

Further, the controller 30 is also configured such that it restores the power of the excitation light source 2 back to the power for the normal condition (where no condensation has been formed) in a case where condensation is no longer detected by the condensation sensor 20. Thereby, a desired illumination light is able to be obtained. Note that, even with power that is equal to or lower than a predetermined value, when the laser light is applied to the fluorescent member 5, heat is generated at the fluorescent member 5 to raise the temperature inside the body 40, and this helps gradually eliminate condensation inside the body 40. A rise in the outside air temperature also helps gradually eliminate condensation inside the body 40.

The present embodiment is, as described above, provided with the condensation sensor 20 that detects condensation near the optical path of the laser light, and the controller 30 that limits irradiation of laser light onto the fluorescent member 5 in a case where the condensation sensor 20 has detected condensation. Thereby, it is possible to limit the irradiation of laser light onto the fluorescent member 5 via the controller 30, and this helps reduce leakage of the laser light out of the illuminating device 1 caused by the laser light being reflected or refracted by water droplets, the laser light having such high power that it exerts harmful effects on human eyes. This helps make the illuminating device 1 more eye-friendly.

Further, as described above, the controller 30 controls the power of the excitation light source 2 emitting laser light to be equal to or lower than the predetermined value. Thereby, it is possible to easily reduce leakage out of the illuminating device 1 of the laser light having such high power that it exerts harmful effects on human eyes.

Further, as described above, by the controller 30 lowering the power of the excitation power source 2 to zero, it is possible to securely prevent the laser light from exerting harmful effects on human eyes.

Further, as described above, the condensation sensor 20 has the function of measuring electric resistance and relative humidity. Thereby, it is possible to easily detect condensation by means of the condensation sensor 20.

Further, as described above, the body 40 is provided inside which the fluorescent member 5 is disposed, and the condensation sensor 20 detects condensation inside the body 40. Thereby, it is possible to detect condensation near the fluorescent member 5, and this is particularly advantageous.

Further, as described above, the provision of the light guide member 4 that guides laser light emitted from the excitation light source 2 makes it possible to easily guide the laser light emitted from the excitation light source 2 to the fluorescent member 5.

Further, as described above, by putting the light guide member 4 through the inlet 7b without a gap therebetween, it is possible to prevent dust or the like from entering the space S1 through the inlet 7b. Thereby, it is possible to reduce deviation of the laser light from the defined beam path caused by the laser light hitting dust or the like.

Further, as described above, by providing the inlet 7b in the body 40, it is possible to easily allow the laser light emitted from the excitation light source 2 into the space S1.

### Second Embodiment

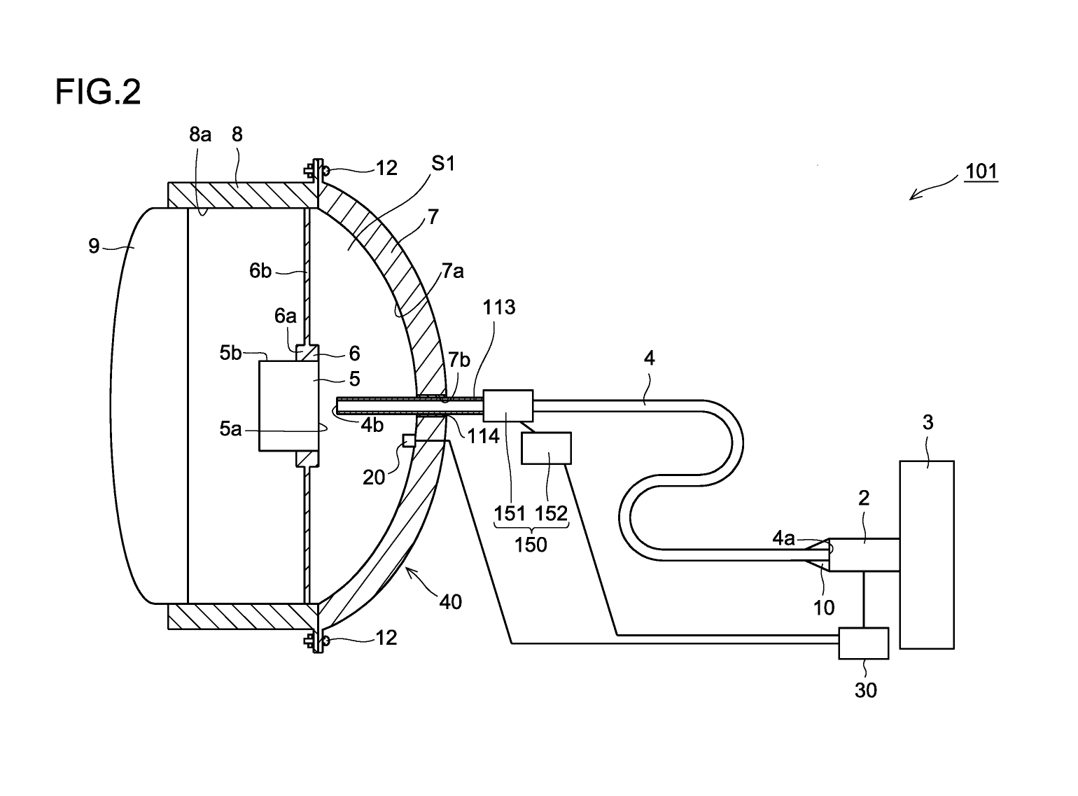

An illuminating device 101 of a second embodiment of the present invention includes, as shown in FIG. 2, a condensation removing unit 150 that removes condensation on a laser-light-passing surface. Note that the laser-light-passing surface means a surface through which laser light passes, and in the present embodiment, a laser-light-exit surface of an excitation light source 2, a laser-light-entrance surface 4a and a laser-light-exit surface 4b of a light guide member 4, and an irradiated surface 5a of a fluorescent member 5 are laser-light-passing surfaces. In the present embodiment, the condensation removing unit 150 removes condensation on the laser-light-exit surface 4b of the light guide member 4 among the laser-light-passing surfaces mentioned above.

The condensation removing unit 150 includes a heater 151 having a heating function, and a heater controller 152 that controls an operation of the heater 151.

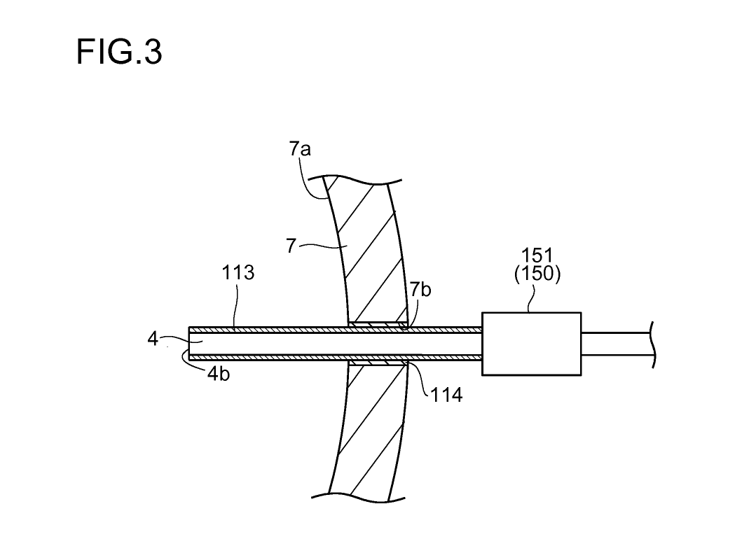

Here, as shown in FIGS. 2 and 3, the light guide member 4 has a heat conductive layer 113 (a heat conductive portion) on an external surface thereof on the laser-light-exit surface 4b side. The heat conductive layer 113 extends to the laser-light-exit surface 4b. The heat conductive layer 113 is connected to the heater 151, and has a function of transferring heat generated by the heater 151 to the laser-light-exit surface 4b.

The heat conductive layer 113 may be a metal wire mesh or may be an electrically conductive film laid on the surface of the light guide member 4. Between an external surface of the heat conductive layer 113 and an internal surface of an inlet 7b of a reflection member 7, there is provided an insulating member 114 formed of, for example, resin. Thereby, it is possible to reduce escape of heat from the heat conductive layer 113 to the reflection member 7.

There may further be provided a coating (not shown) of an insulating resin, for example, to cover the external surface of the heat conductive layer 113. With this configuration, it is possible to prevent the heat conductive layer 113 from being corroded by water droplets or the like. In a case where the external surface of the heat conductive layer 113 is coated with an insulating resin or the like, or in a case where the reflection member 7 is formed of resin or the like, the insulating member 114 is not necessary.

The heater 151 is preferably disposed close to the laser-light-exit surface 4b of the light guide member 4. With this configuration, it is possible to transfer the heat generated by the heater 151 quickly to the laser-light-exit surface 4b. It is also possible to dispose the heater 151 inside the body 40, but, for the purpose of preventing absorption of light by the heater 151 or reflection of light by the heater 151 toward unexpected directions, it is preferable to dispose the heater 151 outside the body 40.

The heater controller 152 is, as shown in FIG. 2, connected to the heater 151 via an unillustrated power supply portion, and the heater controller 152 is configured to control an operation (turning on/off) of the heater 151. The heater controller 152 is connected also to the controller 30. The heater controller 152 receives a signal that corresponds to whether or not the condensation sensor 20 has detected condensation.

The heater controller 152 is configured such that it does not turn on the heater 151 in a case where the condensation sensor 20 has not detected condensation. Also, the heater controller 152 is configured such that it turns on the heater 151 in a case where the condensation sensor 20 has detected condensation. Thereby, if there is condensation already formed inside the body 40 when a driver turns on the illuminating device 101, the heater 151 is turned on and the condensation on the laser-light-exit surface 4b of the light guide member 4 is removed.

Also, the heater controller 152 is configured such that it turns off the heater 151 in a case where condensation is no longer detected by the condensation sensor 20.

The heater controller 152 may be connected directly to the condensation sensor 20, instead of via the controller 30. The heater controller 152 and the controller 30 may be configured as one controller. With this configuration, it is possible to reduce the number of components, and thus to make the illuminating device 101 compact.

In other respects, the structure of the second embodiment is similar to that of the first embodiment described above.

The present embodiment is, as described above, provided with the condensation removing unit 150 that removes condensation on the laser-light-exit surface 4b (a laser-light-passing surface) of the light guide member 4 (a member disposed in the optical path of the laser light). Thereby, it is possible to obtain desired illumination light by releasing limitation on the irradiation of the laser light onto the fluorescent member 5 after the condensation on the laser-light-exit surface 4b is removed by the condensation removing unit 150.

Further, as described above, the condensation removing unit 150 includes the heater 151 for heating the laser-light-exit surface 4b (a laser-light-passing surface). This makes it possible to easily remove condensation on the laser-light-exit surface 4b.

Further, as described above, the light guide member 4 has the heat conductive layer 113 on a surface thereof, and the heat conductive layer 113 transfers heat generated by the heater 151 to the laser-light-exit surface 4b of the light guide member 4. Thereby, it is possible to transfer the heat generated by the heater 151 easily to the laser-light-exit surface 4b. This makes it possible to easily remove condensation on the laser-light-exit surface 4b.

Other advantages of the second embodiment are similar to those of the first embodiment described above.

### Third Embodiment

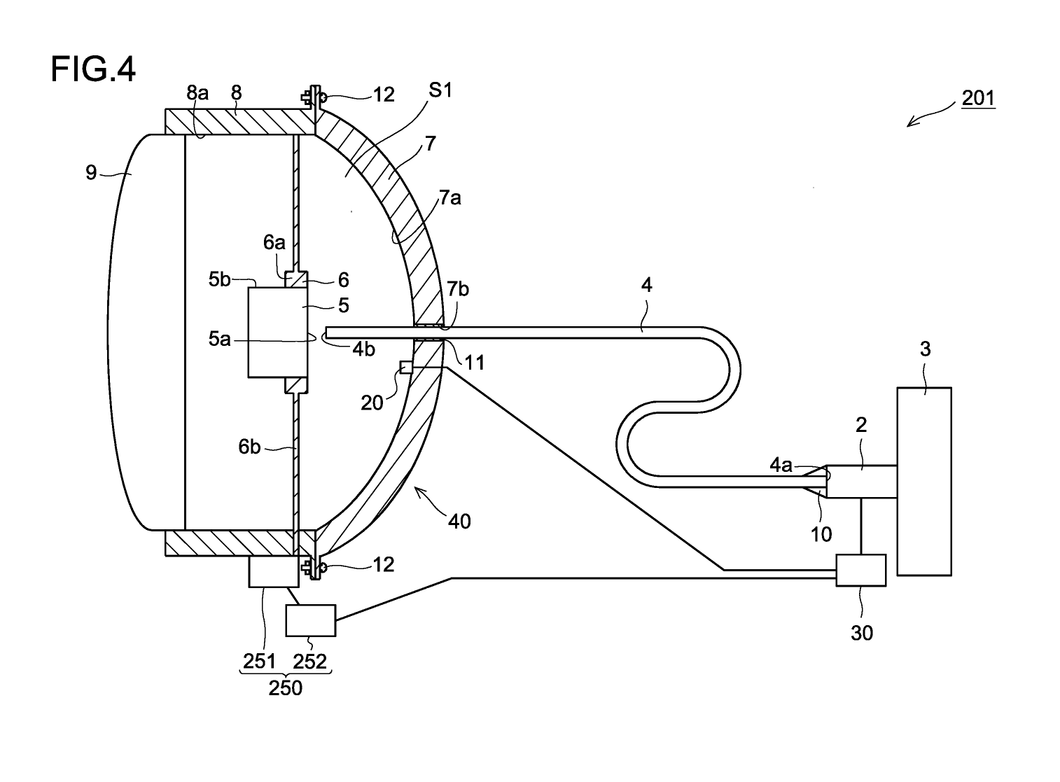

As shown in FIG. 4, an illuminating device 201 of a third embodiment of the present invention includes a condensation removing unit 250 that includes a heater 251 having a heating function, and a heater controller 252 that controls an operation of the heater 251. In the present embodiment, the condensation removing unit 250 is configured such that it removes condensation on an irradiated surface 5a (a laser-light-passing surface) of a fluorescent member 5 (a member disposed in an optical path of laser light).

The heater 251 has a function of heating the fluorescent member 5. The heater 251 is thermally connected to fitting portions 6b of a support member 6, and heat generated by the heater 251 is transferred via the support member 6 to the fluorescent member 5.

The heater controller 252 is connected to the heater 251 and the controller 30, and configured similar to the heater controller 152 of the second embodiment.

In other respects, the structure of the third embodiment is similar to those of the first and second embodiments described above.

The present embodiment is, as described above, provided with the condensation removing unit 250 that removes condensation on the irradiated surface 5a (a laser-light-passing surface) of the fluorescent member 5 (a member disposed in an optical path of laser light). Thereby, it is possible to obtain desired illumination light by releasing limitation on the irradiation of the laser light onto the fluorescent member 5 after the condensation on the irradiated surface 5a is removed by the condensation removing unit 250.

The temperature of a member having high heat conductivity drops faster than that of a member having low heat conductivity, and thus, condensation is liable to occur on a surface of a member having high heat conductivity. In the present embodiment, the support member 6 disposed near the fluorescent member 5 has high heat conductivity for efficient heat dissipation, and as a result, condensation is liable to occur around the support member 6. This leads to a possibility that water droplets from such condensation may flow from the support member 6 to the fluorescent member 5 to reflect and deviate the laser light from the defined beam path. Furthermore, in a case where the reflection member 7 is made of metal, condensation is liable to be formed on an internal surface (a reflection surface 7a) of the reflection member 7. In this case, there is a possibility that water droplets sticking to the internal surface (the reflection surface 7a) of the reflection member 7 may drip down onto the fluorescent member 5, where the water droplets may deviate the laser light from the defined beam path. According to the present embodiment, as described above, since it is possible to remove condensation on the irradiated surface 5a of the fluorescent member 5, even in a case where a member having high heat conductivity is used, for example, around the fluorescent member 5, it is possible to reduce deviation of the laser light from the defined beam path.

Other advantages of the third embodiment are similar to those of the first and second embodiments described above.

### Fourth Embodiment

A fourth embodiment will be described by dealing with a case where a light guide member 304 is formed of a lens as shown in FIG. 5.

An illuminating device 301 of the fourth embodiment of the present invention includes an excitation light source 2, a heat dissipation member 3, a light guide member 304 disposed anterior to the excitation light source 2, a fluorescent member 5, a support member 306 that supports the fluorescent member 5, a reflection member 307 that outwardly reflects fluorescence emitted from the fluorescent member 5, a transmissive member 309 that transmits the fluorescence and emits the fluorescence to outside the illuminating device 301, a condensation sensor 20 that detects condensation inside a later-described body 340 (condensation inside a space S301 described later), and a controller 30 that limits irradiation of laser light onto the fluorescent member 5. In the present embodiment, the body 340 is composed of the reflection member 307, a later-described transmissive member 315, the support member 306, and the transmissive member 309. The space S301 is formed inside the body 340.

The light guide member 304 is formed of a lens (for example, a biconvex lens). The light guide member 304 is disposed outside the body 340.

The support member 306, which may be formed of metal, resin, etc., is formed such that at least part (a holding portion 306a) of the support member 306 around the fluorescent member 5 is formed of a material having high heat conductivity such as metal. The holding portion 306a is configured to dissipate heat generated at the fluorescent member 5 to the entire support member 306, an unillustrated metal member, etc. It is preferable that an internal surface 306b (one of the surfaces that form the space S301) of the support member 306 be a reflection surface that has a function of reflecting light.

The reflection member 307 has a function of reflecting fluorescence, which is emitted from the fluorescent member 5, toward outside the illuminating device 301. A reflection surface 307a of the reflection member 307 includes, for example, a part of a paraboloid, and more specifically, the reflection surface 307a is formed in a shape obtained by dividing a paraboloid by a plane that is parallel to an axis (a rotation axis of the paraboloid) connecting a vertex and a focal point of the paraboloid. Further, at a predetermined position in the reflection member 307, there is provided an inlet 307b for allowing the laser light (the excitation light) emitted from the excitation light source 2 into the space S301.

The inlet 307b is provided with the transmissive member 315 that transmits at least the laser light (the excitation light). The transmissive member 315 is formed of, for example, inorganic glass such as quartz glass and others, resin, etc. Besides, the transmissive member 315 may be configured to reflect fluorescence emitted from the fluorescent member 5. With this configuration, it is possible to prevent the fluorescence from returning toward the excitation light source 2, and thus, it is possible to improve light usage efficiency.

The transmissive member 309 is, for example, a plate-shaped member formed of glass, resin, etc. The transmissive member 309 may be formed of a lens. The transmissive member 309 is fixed to the reflection member 307 and the support member 306.

The condensation sensor 20 is disposed inside the body 340, and more specifically, for example, on the internal surface 306b of the support member 306. The condensation sensor 20 may be disposed at a position out of the holding portion 306a in the support member 306, or may be disposed on the holding portion 306a.

In other respects, the structure of the fourth embodiment is similar to that of the first embodiment described above.

The present embodiment includes, as described above, the condensation sensor 20 that detects condensation near the optical path of the laser light and the controller 30 that limits the irradiation of the laser light onto the fluorescent member 5 in a case where the condensation sensor 20 has detected condensation. Thereby, it is possible to limit the irradiation of the laser light onto the fluorescent member 5 via the controller 30, and this makes it possible to reduce leakage of the laser light out of the illuminating device 301 caused by the laser light being reflected or refracted by water droplets, the laser light having such high power that it exerts harmful effects on human eyes. This helps make the illuminating device 301 more eye-friendly.

Further, as described above, the inlet 307b is provided with the transmissive member 315 that transmits the laser light. Thereby, it is possible to prevent entry of dust or the like into the space S301 through the inlet 307b. This makes it possible to reduce deviation of the laser light from the defined beam path caused by the laser light hitting dust or the like.

Other advantages of the fourth embodiment are similar to those of the first embodiment described above.

### Fifth Embodiment

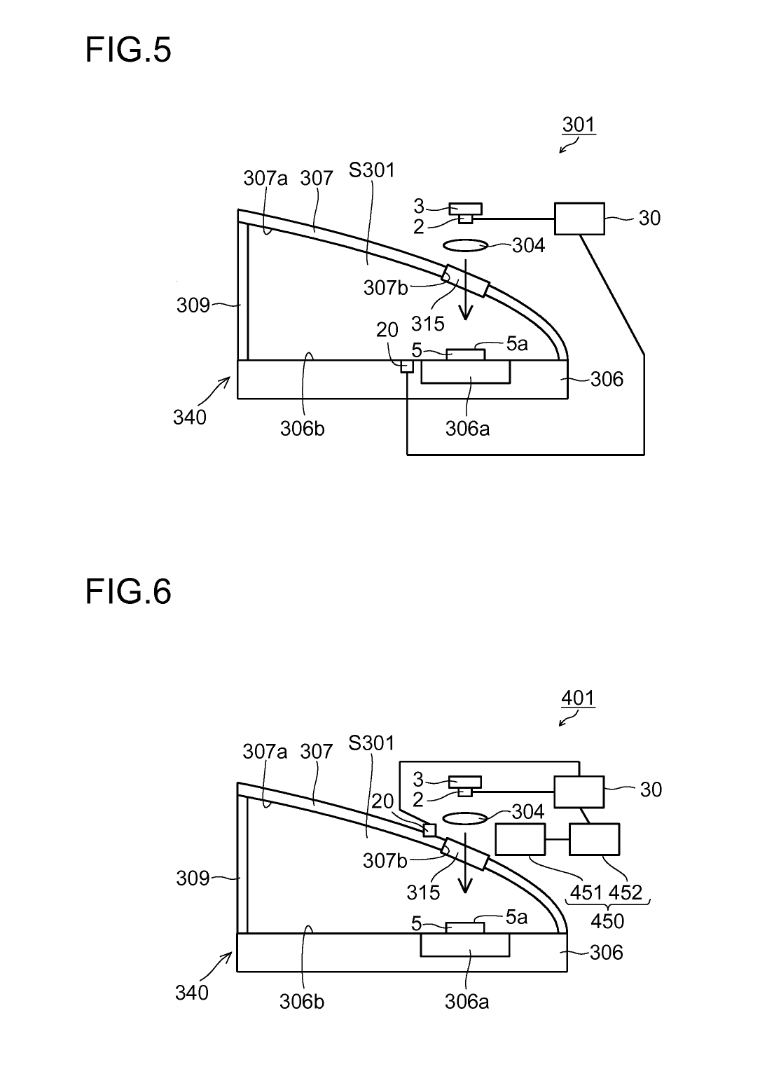

An illuminating device 401 of a fifth embodiment of the present invention includes, as shown in FIG. 6, a condensation removing unit 450 that removes condensation on a laser-light-passing surface. In the present embodiment, a laser-light-exit surface of an excitation light source 2, a laser-light-entrance surface and a laser-light-exit surface of a light guide member 304, a laser-light-entrance surface and a laser-light-exit surface of a transmissive member 315, and an irradiated surface 5a of a fluorescent member 5 are laser-light-passing surfaces.

A condensation sensor 20 is disposed outside a body 340, and more specifically, for example, on an external surface of a reflection member 307. Besides, the condensation sensor 20 is located also close to the light guide member 304 and the transmissive member 315. In the present embodiment, the condensation sensor 20 detects condensation in a space (a space including an optical path of laser light) near the light guide member 304 and the transmissive member 315.

The condensation removing unit 450 includes a heater 451 having a heating function, and a heater controller 452 that controls an operation of the heater 451.

The heater 451 has a function of heating the transmissive member 315. The heater 451 and the transmissive member 315 may be thermally connected to each other via a heat conductive member (not shown) to transfer heat generated by the heater 451 to the transmissive member 315. A blower may be provided near the heater 451 such that the heat generated by the heater 451 is blown to heat the surface (laser-light-passing surfaces) of the transmissive member 315.

The heater 451 may be configured to heat surfaces (laser-light-entrance and laser-light-exit surfaces) not only of the transmissive member 315 but also of the transmissive member 304, and the laser-light-exit surface of the excitation light source 2 as well. Note that the heater 451 may be configured to heat only the surface of the light guide member 304 or only the laser-light-exit surface of the excitation light source 2. This is because which part of the illuminating device 401 is prone to condensation depends on the structure, material, location, and the like of the illuminating device 401.

The heater controller 452 is connected to the heater 451 and the controller 30, and configured similar to the heater controllers of the above-described embodiments.

In other respects, the structure of the fifth embodiment is similar to that of the fourth embodiment described above.

The present embodiment includes, as described above, the condensation removing unit 450 that removes condensation on the surfaces (laser-light-passing surfaces) of the transmissive member 315, the light guide member 304, etc. Thereby, it is possible to obtain desired illumination light by releasing limitation on irradiation of the laser light onto the fluorescent member 5 after condensation on the surfaces of the transmissive member 315, the light guide member 304, etc. is removed by the condensation removing unit 450.

Furthermore, as described above, the condensation removing unit 450 includes the heater 451 for heating the surfaces (the laser-light-passing surfaces) of the transmissive member 315, the light guide member 304, etc. Thereby, it is possible to easily remove condensation on the surfaces of the transmissive member 315, the light guide member 304, etc.

As described above, the transmissive member 315 may be formed of inorganic glass such as quartz glass and others. Inorganic glass such as quarts glass and others has higher heat conductivity than resin. Thus, the surface of the transmissive member 315 is prone to condensation. According to the present embodiment, as described above, it is possible to remove condensation on the surface of the transmissive member 315, and thus, even in a case where a member having high heat conductivity is used, for example, as the transmissive member 315, it is possible to reduce deviation of the laser light from the defined beam path.

Other advantages of the fifth embodiment are similar to those of the fourth embodiment described above.

### Sixth Embodiment

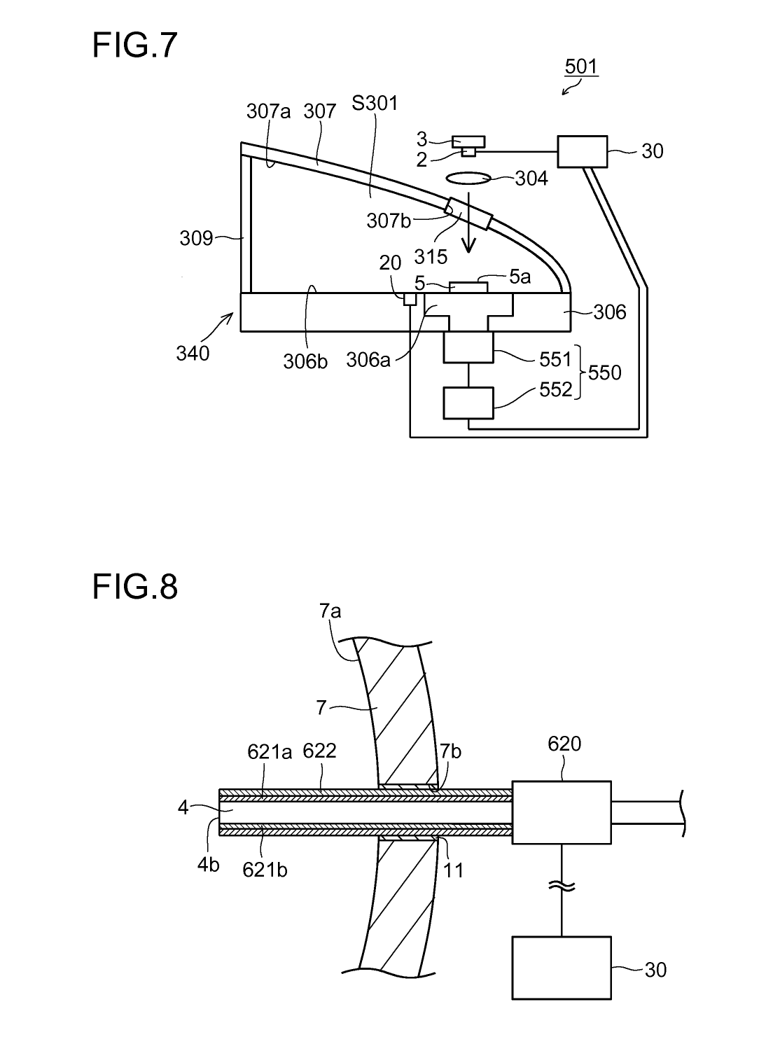

As shown in FIG. 7, an illuminating device 501 of a sixth embodiment of the present invention includes a condensation removing unit 550 that includes a heater 551 having a heating function, and a heater controller 552 that controls an operation of the heater 551. In the present embodiment, the condensation removing unit 550 is configured such that it removes condensation on an irradiated surface 5a (a laser-light-passing surface) of a fluorescent member 5 (a member disposed in an optical path of laser light).

The heater 551 has a function of heating the fluorescent member 5. The heater 551 is thermally connected to a holding portion 306a of a support member 306, and heat generated by the heater 551 is transferred via the support member 306 to the fluorescent member 5.

The heater controller 552 is connected to the heater 551 and a controller 30, and configured similar to the heater controllers of the above-described embodiments.

In other respects, the structure of the third embodiment is similar to those of the fourth and fifth embodiments described above.

Advantages of the sixth embodiment are similar to those of the third to fifth embodiments described above.

### Seventh Embodiment

As shown in FIG. 8, in an illuminating device of a seventh embodiment of the present invention, a condensation sensor 620 is configured so as to detect condensation on a laser-light-exit surface 4b of a light guide member 4.

The condensation sensor 620 includes two wirings 621a and 621b formed on an external surface of the light guide member 4 on the laser-light-exit surface 4b side. The wirings 621a and 621b extend to the laser-light-exit surface 4b. The wirings 621a and 621b may each be a metal wire or an electrically conductive film laid on the surface of the light guide member 4. In addition, external surfaces of the wirings 621a and 621b are each coated with an insulating layer 622 formed of resin or the like. An end portion of each of the wirings 621a and 621b on the laser-light-exit surface 4b side is an electrode.

The condensation sensor 620 detects condensation on the laser-light-exit surface 4b of the light guide member 4 by detecting change in electric resistance on the laser-light-exit surface 4b of the light guide member 4 (change in electric resistance between the electrodes of the wirings 621a and 621b).

In other respects, the structure of the seventh embodiment is similar to that of the first embodiment described above.

in the present embodiment, as described above, the provision of the condensation sensor 620 makes it possible to detect condensation on the laser-light-exit surface 4b of the light guide member 4.

Other advantages of the fifth embodiment are similar to those of the first embodiment described above.

### Eighth Embodiment

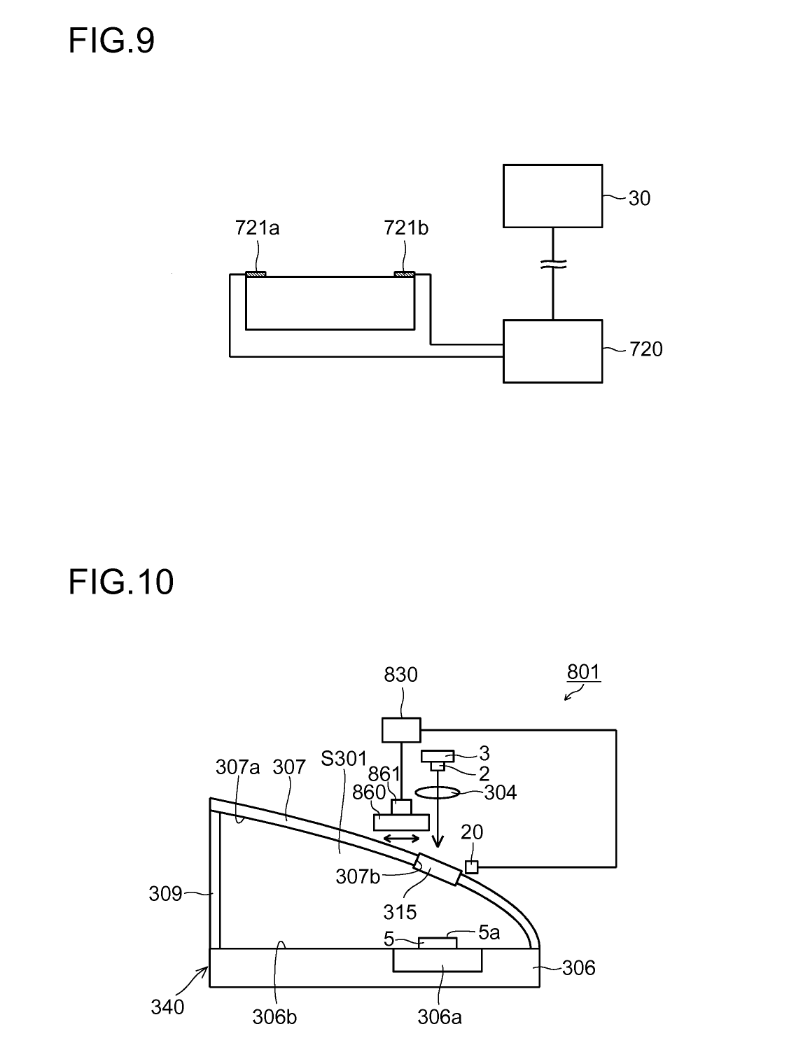

As shown in FIG. 9, in an illuminating device of an eighth embodiment of the present invention, a condensation sensor 720 is configured so as to detect condensation on an illuminated surface 5a of a fluorescent member 5.

The condensation sensor 720 includes two electrodes 721a and 721b which are provided on the irradiated surface 5a of the fluorescent member 5. The electrodes 721a and 721b may be made by forming a conductive film (for example, an ITO (indium tin oxide) film) on the irradiated surface 5a of the fluorescent member 5.

The condensation sensor 720 detects condensation on the irradiated surface 5a of the fluorescent member 5 by detecting a change in electric resistance on the irradiated surface 5a of the fluorescent member 5 (a change in electric resistance between the electrodes 721a and 721b).

In other respects, the structure of the eighth embodiment is similar to those of the first and second embodiments described above.

In the present embodiment, as described above, the provision of the condensation sensor 720 makes it possible to detect condensation on the irradiated surface 5a of the fluorescent member 5.

Other advantages of the eighth embodiment are similar to those of the first embodiment described above.

### Ninth Embodiment

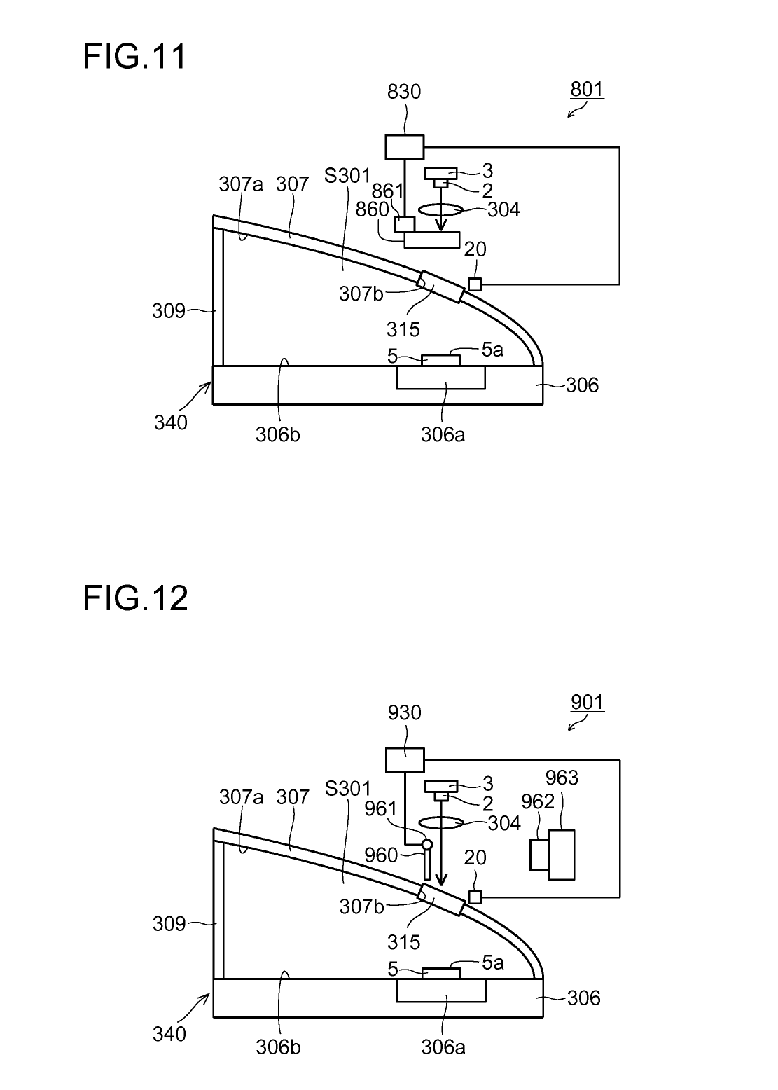

A ninth embodiment will be described by dealing with a case where, as shown in FIGS. 10 and 11, there is provided a light-blocking member 860 that blocks an optical path of laser light.

In an illuminating device 801 of the ninth embodiment of the present invention, as shown in FIG. 10, a condensation sensor 20 is provided so as to detect condensation near the optical path of the laser light outside a body 340. The condensation sensor 20 is placed, for example, near a transmissive member 315, and detects condensation near the transmissive member 315. Note that the condensation sensor 20 may be placed, for example, near a light guide member 304 or an excitation light source 2.

To the condensation sensor 20 is connected a controller 830 that limits the irradiation of the laser light onto a fluorescent member 5. In the present embodiment, the controller 830 is connected to a position controller 861 that moves the light-blocking member 860. The position controller 861 is achieved by using, for example, a motor, and has a function of inserting or withdrawing the light-blocking member 860 into or from the optical path of the laser light (the defined beam path).

The light-blocking member 860 may be formed of for example, an absorber that absorbs laser light. Further, the light-blocking member 860 may be provided with a heat dissipation member (not shown) for dissipating heat generated when laser light is absorbed.

Further, as shown in FIG. 11, in a case where the condensation sensor 20 has detected condensation, the controller 830 sends a signal to the position controller 861 to instruct the position controller 861 to insert the light-blocking member 860 into the optical path of the laser light (the defined beam path). Further, as shown in FIG. 10, in a case where the condensation sensor 20 has not detected condensation, the controller 830 sends a signal to the position controller 861 to instruct the position controller 861 to withdraw the light-blocking member 860 from the optical path of the laser light (the defined beam path). Thereby, when a driver turns on the illuminating device 801, if condensation has formed on, for example, the surface of the transmissive member 315, the light-blocking member 860 is inserted into the optical path of the laser light (the defined beam path), to block the optical path of the laser light. After the condensation is eliminated, the light-blocking member 860 is withdrawn from the optical path of the laser light, and desired illumination light is obtained.

In other respects, the structure of the ninth embodiment is similar to that of the fourth embodiment described above.

In the present embodiment, as described above, the controller 830 puts the light-blocking member 860 into the optical path of the laser light. Thereby, it is possible to easily block the optical path of the laser light, and thus, it is possible to easily reduce leakage of the laser light out of the illuminating device 801.

Other advantages of the ninth embodiment are similar to those of the fourth embodiment described above.

It should be understood that, although the present embodiment has been described by dealing with the case where the condensation sensor 20 is provided so as to detect condensation outside the body 340, this is not meant to limit the present invention. Even in a case where the condensation sensor 20 is provided so as to detect condensation inside the body 340, the same effect is able to be achieved by putting the light-blocking member 860 into the optical path of the laser light.

### Tenth Embodiment

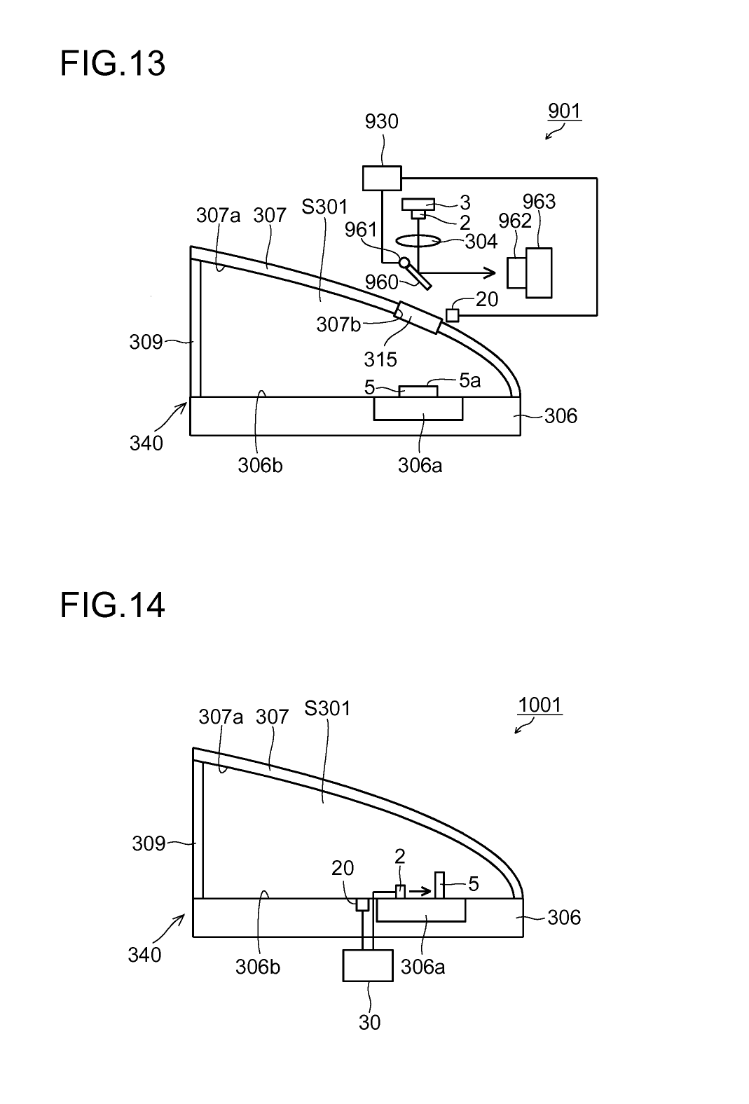

A tenth embodiment will be described by dealing with a case where, as shown in FIGS. 12 and 13, there is provided an optical path changing member 960 that changes an optical path of laser light.

In an illuminating device 901 of the tenth embodiment of the present invention, as shown in FIG. 12, a condensation sensor 20 is connected to a controller 930 that limits the irradiation of the laser light onto the fluorescent member 5. In the present embodiment, the controller 930 is connected to an angle controller 961 which changes an angle of the optical path changing member 960. The angle controller 961 is achieved by using, for example, a motor, and has a function of rotating the optical path changing member 960 to insert or withdraw the optical path changing member 960 into or from the optical path of the laser light (the defined beam path).

The optical path changing member 960 is formed of, for example, a reflection mirror.

Further, as shown in FIG. 13, in a case where the condensation sensor 20 has detected condensation, the controller 930 sends a signal to the angle controller 961 to instruct the angle controller 961 to insert the optical path changing member 960 into the optical path of the laser light (the defined beam path). Further, as shown in FIG. 12, in a case where the condensation sensor 20 has not detected condensation, the controller 930 sends a signal to the angle controller 961 to instruct the angle controller 961 to withdraw the optical path changing member 960 from the optical path of the laser light (the defined beam path). Thereby, when a driver turns on the illuminating device 901, if condensation has formed on, for example, the surface of a transmissive member 315, the optical path changing member 960 is inserted into the optical path of the laser light (the defined beam path), and thereby the optical path of the laser light is changed. After the condensation is eliminated, the optical path changing member 960 is withdrawn from the optical path of the laser light, and desired illumination light is obtained.

Further, it is preferable to provide a beam stop 962 in the changed path of the laser light as shown in FIG. 13. The beam stop 962 may be formed of an absorber that absorbs laser light, a reflecting diffuser that sufficiently reflects and diffuses laser light, etc. The beam stop 962 may be provided with a heat dissipation member 963 for dissipating heat.

In other respects, the structure of the tenth embodiment is similar to those of the fourth and ninth embodiments described above.

In the present embodiment, as described above, the controller 930 changes the angle of the optical path changing member 960 to insert the optical path changing member 960 into the optical path of the laser light. Thereby, it is possible to easily change the optical path of the laser light, and thus to easily reduce leakage of laser light out of the illuminating device 901.

In addition, the beam stop 962 is disposed in the optical path of the laser light changed by the optical path changing member 960. Thereby, it is possible to easily stop the laser light (for example, by absorbing the laser light), and thus to easily reduce leakage of the laser light out of the illuminating device 901.

Other advantages of the tenth embodiment are similar to those of the fourth embodiment described above.

It should be understood that, although the present embodiment has been described by dealing with the case where the condensation sensor 20 is provided so as to detect condensation outside the body 340, this is not meant to limit the present invention. Even in a case where the condensation sensor 20 is provided so as to detect condensation inside the body 340, the same effect is able to be achieved by changing the optical path of the laser light.

Note that the first to tenth embodiments disclosed above are to be considered in all respects as illustrative and not restrictive. The scope of the present invention is set out in the appended claims and not in the descriptions of the embodiments hereinabove, and includes any variations and modifications within the sense and scope equivalent to those of the claims.

For example, the foregoing descriptions of the first to tenth embodiments each have dealt with an example where an illuminating device of the present invention is applied to an automobile headlamp, but this is not meant to limit the present invention. Illuminating devices of the present invention may be applied to headlamps of other moving bodies such as airplanes, ships, robots, motorcycles, bicycles, etc.

The foregoing descriptions of the first to tenth embodiments have dealt with examples where illuminating devices of the present invention are applied to headlamps, but this is not meant to limit the present invention. The illuminating devices of the present invention may be applied to down lights, spot lights, and other illuminating devices. Further, the illuminating devices of the present invention may be applied to illuminating devices having no reflection member such as electric light bulb-type illuminating devices.

The foregoing descriptions of the first to tenth embodiments each have dealt with examples where the excitation light is converted into visible light, but this is not meant to limit the present invention, and the excitation light may be converted into light other than visible light. For example, in a case where excitation light is converted into infrared light, the illuminating devices of the present invention are also applicable to nighttime illuminating devices for security CCD cameras.

Further, the foregoing descriptions of the first to tenth embodiments have dealt with examples where the excitation light source and the fluorescent member are configured such that white light is emitted, but this is not meant to limit the present invention. The excitation light source and the fluorescent member may be configured such that light of a color other than white is emitted.

Further, the foregoing descriptions of the first to tenth embodiments have dealt with examples where a semiconductor laser element is used as the excitation light source that emits laser light, but this is not meant to limit the present invention, and an excitation light source other than a semiconductor laser element may be used.

Furthermore, the foregoing descriptions of the first to tenth embodiments have dealt with examples where the reflection surface of the reflection member includes a part of a paraboloid, but this is not meant to limit the present invention, and the reflection surface may include, for example, a part of an ellipsoid. In this case, by positioning an irradiated area of the fluorescent member at the focal point of the reflection surface, it is possible to easily collect light emitted from the illuminating device. Alternatively, the reflection surface may be a multi-reflecting surface composed of a large number of curved surfaces (for example, paraboloidal surfaces) or a freely-curved reflecting surface composed of a large number of minute flat surfaces that are continuously arranged.

Further, the foregoing descriptions of the first to tenth embodiments each have dealt with an example where an optical fiber or a lens is used as the light guide member, but this is not meant to limit the present invention. A reflection mirror may be used as the light guide member, or alternatively, two or more from an optical fiber, a lens, a reflection mirror, and the like may be used in combination. Note that the light guide member is provided as necessary, and it is not indispensable in a case where the excitation light source 2 is disposed near the fluorescent member 5 like, for example, in an illuminating device 1001 of a first modified example of the present invention shown in FIG. 14. In the illuminating device 1001, an excitation light source 2 and a fluorescent member 5 are disposed inside a main body 340.

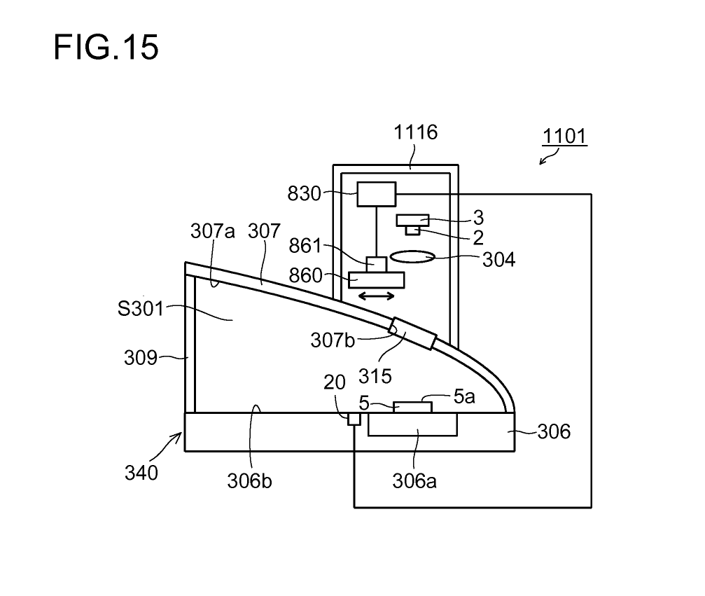

Note that, unlike in the above-described first to tenth embodiments, a cover member may be provided to cover an excitation light source, a light guide member, etc. disposed outside a body. For example, like in an illuminating device 1101 of a second modified example of the present invention shown in FIG. 15, a cover member 1116 may be provided to cover an excitation light source 2 and a light guide member 304. The cover member 1116 has a function of blocking the excitation light, and may be formed of, for example, resin, metal, etc.

Further, the foregoing descriptions of the fourth to sixth, ninth, and tenth embodiments have dealt with examples where the inlet 307b is provided with the transmissive member 315, but this is not meant to limit the present invention, and the inlet 307b may be without the transmissive member 315. Besides, if the cover member 1116 is provided like in the above-mentioned second modified example, even in a case where the transmissive member 315 is not provided, it is possible to prevent dust or the like from entering the space S301 through the inlet 307b.

Further, the foregoing descriptions of the second, third, fifth, and sixth embodiments have dealt with examples where the condensation removing unit is provided with the heater, but this is not meant to limit the present invention. The condensation removing unit may be provided with, for example, a dehumidifier, a blower, etc. instead of a heater. In such a case as well, it is possible to remove condensation.

Further, the foregoing descriptions of the first to tenth embodiments have dealt with examples where the reflection member is provided with the inlet, but this is not meant to limit the present invention. For example, the inlet may be formed in the support member 306 of the fourth embodiment.

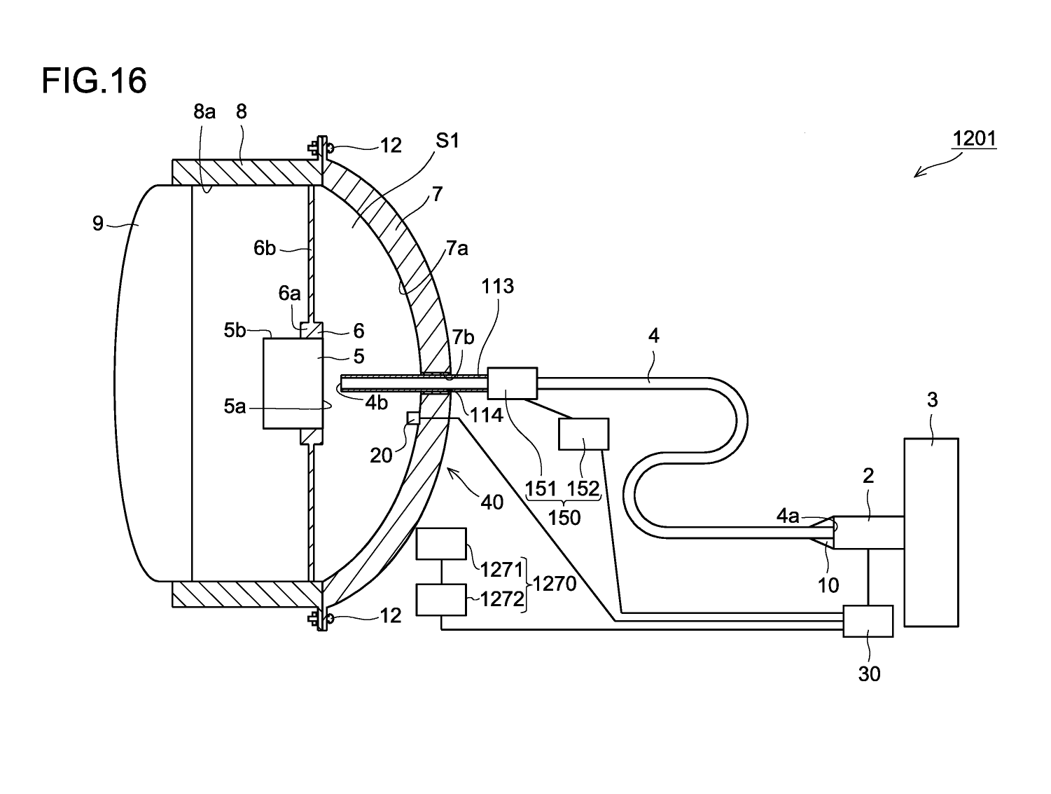

Further, the foregoing descriptions of the second, third, fifth, and sixth embodiments have dealt with examples provided with the condensation removing unit for removing condensation on the surface of the light guide member, the surface of the fluorescent member, etc., but this is not meant to limit the present invention. For example, like in an illuminating device 1201 of a third modified example of the present invention shown in FIG. 16, there may be provided a condensation removing unit 1270 for heating the reflection surface 7a of the reflection member 7. The condensation removing unit 1270 includes a heater 1271 having a heating function, and a heater controller 1272 that controls an operation of the heater 1271. The heater 1271 has a function of heating the reflection surface 7a of the reflection member 7. In a case where the reflection member 7 is made of metal, it is possible to heat the reflection surface 7a by heating the external surface of the reflection member 7. In a case where the reflection member 7 is made of resin, for example, by forming the reflection surface 7a of a metal film and disposing the heater 1271 such that heat is able to be transferred to the metal film, it is possible to heat the reflection surface 7a. The heater controller 1272 is configured similar to the heater controllers of the above-described embodiments. Besides, the condensation removing unit 1270 may be configured to heat the bezel 8 and the transmissive member 9 as well, or alternatively, the condensation removing unit 1270 may be configured to heat not the reflection member 7 but the bezel 8 or the transmissive member 9 alone. With such configurations, it is possible to prevent the fluorescence from being reflected or refracted by water droplets on the surface of the reflection member 7, the transmissive member 9, and the like, and this helps reduce cases where the desired illumination light is not able to be obtained.

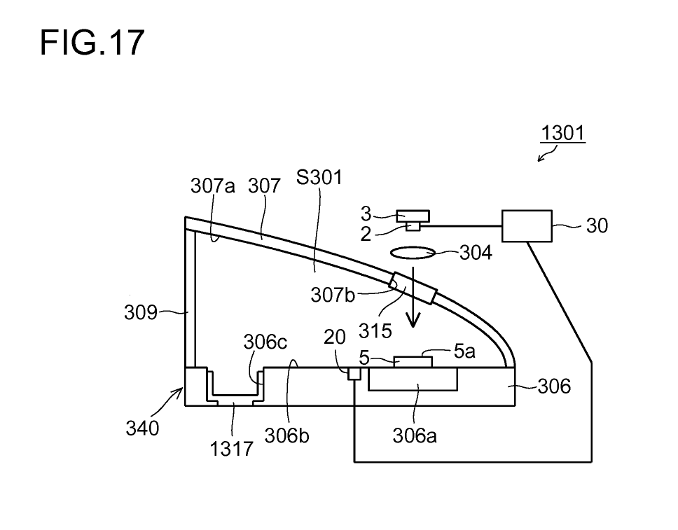

Further, like an illuminating device 1301 of a fourth modified example of the present invention shown in FIG. 17, for example, there may be provided a getter member 1317 that is made of a highly heat conductive material and disposed remote from the fluorescent member 5. It is preferable that the getter member 1317 be as heat-conductive as or more heat-conductive than the holding portion 306a of the support member 306. With this configuration, condensation forms on the getter member 1317 before on the holding portion 306a, and this helps reduce condensation on the holding portion 306a. It is also preferable that the getter member 1317 be disposed in a lower part of the illuminating device 1301. Besides, it is preferable that a recessed portion 306c be formed in an internal surface 306b of the support member 306 to dispose the getter member 1317 inside the recessed portion 306c. With this configuration, it is possible to reduce water droplets formed on a surface of the getter member 1317 to move to other parts. Besides, the getter member 1317 may be exposed to outside of the illuminating device 1301. With this configuration, it is possible to easily lower the temperature of the getter member 1317 before, for example, the temperature of the holding portion 306a.

Further, the foregoing descriptions of the first to tenth embodiments have dealt with examples where the condensation sensor detects condensation by measuring electric resistance or relative humidity, but this is not meant to limit the present invention, and various operation theories may be applied to detect condensation. For example, the condensation sensor may optically detect condensation. Alternatively, a light receiving element may be disposed on a side opposite to an irradiated surface of a fluorescent member such that condensation is detected by measuring intensity of the excitation light passing through the fluorescent member. With this configuration, if condensation forms on the irradiated surface of the fluorescent member, the condensation (water droplets) reflects or refracts laser light, reducing the intensity of the excitation light passing through the fluorescent member, and by detecting such a change in the intensity, it is possible to detect condensation. During this detecting operation, the power of the laser light needs to be lowered sufficiently.

Further, the foregoing description of the ninth embodiment has dealt with an example where a light-blocking member is inserted into an optical path of laser light by changing the location of the light-blocking member, and the foregoing description of the tenth embodiment has dealt with an example where an optical path changing member is inserted into an optical path of laser light by changing the angle of the optical path changing member, but these are not meant to limit the present invention. For example, in the above-described ninth embodiment, the light-blocking member may be inserted into the optical path of the laser light by changing the angle of the light-blocking member, and in the above-described tenth embodiment, the optical path changing member may be inserted into the optical path of the laser light by changing the location of the optical path changing member. Needless to say, the locations and the angles of these members may both be changed to insert them into the optical path of the laser light.

Further, the foregoing description of the tenth embodiment has dealt with an example where the optical path changing member for changing the optical path of the laser light is separately provided, but this is not meant to limit the present invention. An angle controller may be used to change the angle of the light guide member 304. In this case, the light guide member 304 functions as an optical path changing member to change the optical path of the laser light.

Further, the foregoing descriptions of the first to tenth embodiments have dealt with examples where the irradiation of laser light onto the fluorescent member is limited when condensation is detected, but this is not meant to limit the present invention. The irradiation of the laser light may be limited in advance in a case where humidity has reached a level where condensation is likely to occur.

Further, the foregoing description of the eighth embodiment has dealt with an example where the detection sensor 720 is configured to detect condensation on the irradiated surface 5a of the fluorescent member 5, but this is not meant to limit the present invention, and the condensation sensor may be configured to detect condensation, for example, on the surface of the transmissive member 315, on the surface of the light guide member 307, etc.

Further, surface treatment may be applied to the laser-light-passing surfaces. For example, if a thin film of titanium oxide is provided on a laser-light-passing surface, since titanium oxide is hydrophilic, water droplets formed on the laser-light-passing surface are more likely to spread on to wet the laser-light-passing surface. This helps reduce refraction of laser light in an unintended direction. Alternatively, surface treatment may be applied to a laser-light-passing surface such that condensation will form fine water droplets. This configuration helps make it easier to evaporate the water droplets by means of a heater or the like.

Further, the foregoing description of the second embodiment has dealt with an example where the heat conductive layer 113 is provided on the surface of the light guide member 4 such that heat generated by the heater 151 is transferred to the laser-light-exit surface 4b, but this is not meant to limit the present invention. For example, there may be provided a heat generating portion (such as an electric resistor) near the laser-light-exit surface 4b, and a wiring layer may be formed on the surface of the light guide member 4 to be connected to the heat generating portion such that power is supplied via the wiring layer to the heat generating portion to thereby allow the heat generating portion to generate heat for removing condensation on the laser-light-exit surface 4b. In this case, if a coating of an insulating resin or the like is provided to cover the wiring layer and the heat generating portion, it is possible to easily prevent the wiring layer, the heat generating portion, etc. from short-circuiting due to water droplets.

It should be understood that configurations obtained by appropriately combining the configurations of the foregoing embodiments and modified examples are also included in the scope of the present invention. For example, the second and third embodiments may be combined to achieve a structure where condensation is removed off both a laser-light-exit surface of a light guide member and an irradiated surface of a fluorescent member. Or, for example, the fourth embodiment may be combined with the ninth or tenth embodiment to achieve a structure where the optical path of the laser light is blocked or changed while the power of the excitation light source is being lowered.

### Eleventh Embodiment

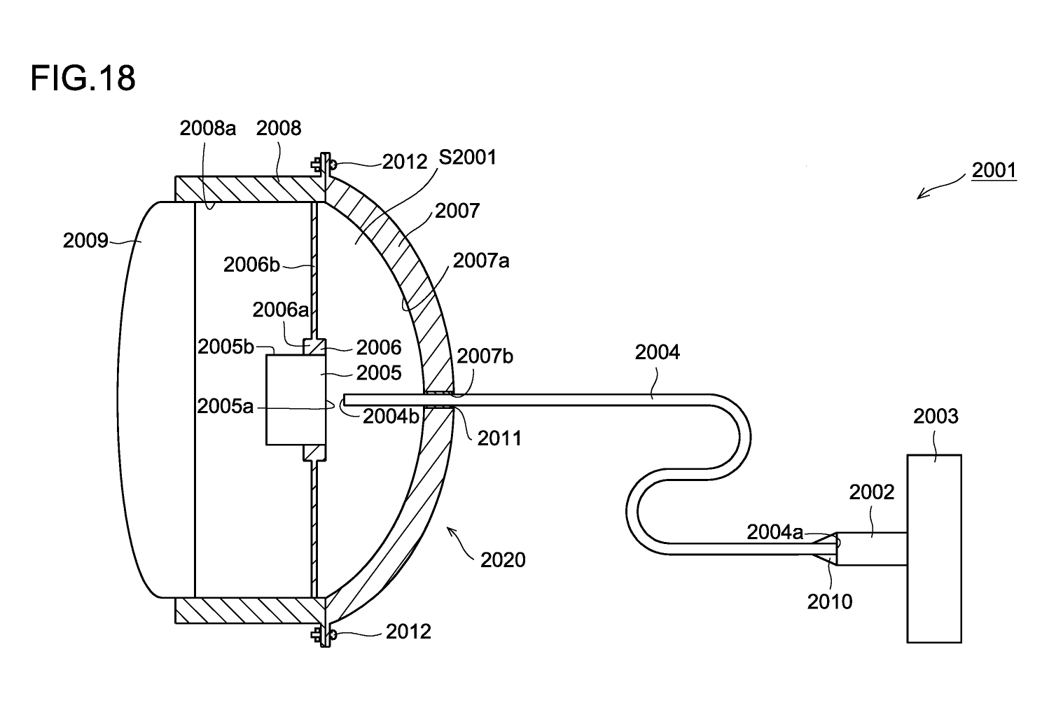

A description will be given of a structure of an illuminating device 2001 of an eleventh embodiment of the present invention with reference to FIG. 18.

The illuminating device 2001 of the eleventh embodiment of the present invention is one that is used as a headlamp that illuminates an area ahead of, for example, an automobile. As shown in FIG. 18, the illuminating device 2001 includes an excitation light source 2002 that emits laser light functioning as excitation light, a heat dissipation member 2003 to which the excitation light source 2002 is fixed, a light guide member 2004 disposed anterior to the excitation light source 2002, a fluorescent member 2005 that is irradiated with the laser light (the excitation light), a support member 2006 that supports the fluorescent member 2005, a reflection member 2007 that reflects fluorescence, which is emitted from the fluorescent member 2005, toward outside the illuminating device 2001, a bezel 2008 that is fixed to a front edge of the reflection member 2007, and a transmissive member 2009 (a first transmissive member) that transmits the fluorescence and emits the fluorescence to outside the illuminating device 2001. The present embodiment includes a body 2020, and the body 2020 is composed of the reflection member 2007, the bezel 2008, the transmissive member 2009, and the like. Inside the body 2020, a hermetic space S2001 is formed.

The excitation light source 2002 is a semiconductor laser configured with a semiconductor laser element (not shown) and a package in which the semiconductor laser element is mounted. The excitation light source 2002 is configured to emit laser light having, for example, a center wavelength of approximately 380 nm to approximately 460 nm. The excitation light source 2002 is disposed outside the hermetic space S2001.

The heat dissipation member 2003 is formed of, for example, a metal block, and has a function of dissipating heat generated in the excitation light source 2002. The heat dissipation member 2003 is provided as necessary, and instead of providing the heat dissipation member 2003, any of the other members may be used also to dissipate the heat.

The light guide member 2004 has a function of guiding the laser light emitted from the excitation light source 2002 to the hermetic space S2001. In the present embodiment, the light guide member 2004 is formed of, for example, an optical fiber.

A laser-light-entrance end surface 2004a side part of the light guide member 2004 is fixed to the excitation light source 2002. A seal member 2010 is provided in such a manner that the seal member 2010 seals the laser-light-entrance end surface 2004a of the light guide member 2004 and a laser-light-exit surface of the excitation light source 2002. A connection portion between the light guide member 2004 and the excitation light source 2002 is formed such that no condensation is allowed in the optical path of the laser light. For example, a transparent seal member 2010 may be provided between the laser-light-entrance end surface 2004a of the light guide member 2004 and the laser-light-exit surface of the excitation light source 2002. Further, the light guide member 2004 may be a pigtail fiber such that the light guide member 2004 and the excitation light source 2002 are pigtail connected to each other. In this case as well, it is possible for the laser-light-entrance surface 2004a of the light guide member 2004 and the laser-light-exit surface of the excitation light source 2002 to be hermetic, and to prevent condensation in the optical path of the laser light in the connection portion between the light guide member 2004 and the excitation light source 2002. For example, resin or the like may be provided between the laser-light-entrance end surface 2004a of the light guide member 2004 and the laser-light-exit surface of the excitation light source 2002, or a dry gas may be sealed in a hermetic space including the laser-light-entrance end surface 2004a of the light guide member 2004 and the laser-light-exit surface of the excitation light source 2002.

With such structures where no condensation is allowed to be formed in the optical path of the laser light in the connection portion between the light guide member 2004 and the excitation light source 2002, it is possible to prevent condensation in the part of the optical path of the laser light (the defined beam path) from the excitation light source 2002 to the laser-light-exit end surface 2004b of the light guide member 2004.

A laser-light-exit end surface 2004b side part of the light guide member 2004 is put through a later-described inlet 2007b of the reflection member 2007 without a gap therebetween. For example, a seal member 2011 is provided between an external surface of the light guide member 2004 and an internal surface of the inlet 2007b of the reflection member 2007. The laser-light-exit end surface 2004b of the light guide member 2004 is located inside the hermetic space S2001.

Further, the laser-light-exit end surface 2004b is located a predetermined distance away from an irradiated surface 2005a of the fluorescent member 2005 which is irradiated with the laser light. Thereby, it is possible to reduce re-entrance of light coming from the irradiated surface 2005a of the fluorescent member 2005 into the light guide member 2004 through the laser-light-exit end surface 2004b, and thus, it is possible to reduce degradation of light usage efficiency.

The fluorescent member 2005 is disposed inside the hermetic space S2001, and has a function of emitting fluorescence by being irradiated with the laser light (the excitation light). In addition, the fluorescent member 2005 emits fluorescence having a center wavelength that is longer than the wavelength of the excitation light. The fluorescent member 2005 includes three kinds of fluorescent substances (not shown) that respectively convert blue-violet laser light into red light, green light, and blue light. The red light, the green light, and the blue light emitted from the fluorescent member 2005 are mixed together, and thereby, white illumination light is obtained. Note that the fluorescent member 2005 may include just one kind of fluorescent substance that converts, for example, part of blue laser light into yellow light. And, white illumination light may be obtained by mixing the yellow light with the blue light scattered by the fluorescent member 2005. The fluorescent member 2005 may be, for example, one that is made by mixing a fluorescent substance with glass, resin, etc., and forming the mixture into a lump, or one that is made by applying pressure to, or sintering, fluorescent particles.

The support member 2006 includes a holding portion 2006a that holds a side surface 2005b of the fluorescent member 2005 and a plurality of rod-shaped fitting portions 2006b which are fitted to the bezel 2008. The holding portion 2006a may hold the side surface of the fluorescent member 2005 either directly or indirectly via a bonding layer or the like. The fitting portions 2006b may be fitted to the reflection member 2007.

In addition, the support member 2006 is formed of a highly heat conductive material such as metal, graphite, etc. The support member 2006 is configured to dissipate heat generated at the fluorescent member 2005 to the bezel 2008, the reflection member 2007, an unillustrated metal block, etc.

The reflection member 2007 has a function of outwardly reflecting light (for example, fluorescence, scattered light) emitted from the fluorescent member 2005. A reflection surface 2007a of the reflection member 2007 is formed concave such that the reflection surface 2007a includes, for example, a part of a paraboloid. In addition, the irradiated surface 2005a of the fluorescent member 2005 is located in an area that includes a focal point of the reflection surface 2007a. At a predetermined position in the reflection member 2007 (for example, at a vertex of the reflection member 2007), the inlet 2007b is provided for allowing the laser light (the excitation light) emitted from the excitation light source 2002 into the hermetic space S2001. The reflection member 2007 is formed of metal, resin, etc. In a case where the reflection member 2007 is formed of resin, the reflection surface 2007a may be formed of, for example, a metal film.

The bezel 2008 is, for example, formed in a cylindrical shape, and fixed to the front edge of the reflection member 2007 with bolts 2012, screws (not shown), etc. without a gap therebetween. The bezel 2008 is formed of metal, resin, etc. It is preferable that an internal surface 2008a of the bezel 2008 is formed as a reflection surface having a function of reflecting light.

The transmissive member 2009 is formed of a lens (for example, a planoconvex lens) made of glass, resin, etc. The transmissive member 2009 is fixed to the internal surface 2008a of the bezel 2008 without a gap therebetween. Between an external surface of the transmissive member 2009 and the internal surface 2008a of the bezel 2008, there may be provided an unillustrated seal member.

In the hermetic space S2001, a dry gas is sealed to prevent condensation. Thereby, all the optical path of the laser light (the defined beam path) from the excitation light source 2002 to the fluorescent member 2005 is sealed up, and it is possible to prevent condensation anywhere in the optical path of the laser light (the defined beam path). As the dry gas, dry air containing an extremely small amount water vapor may be used, or an inert gas such as nitrogen, argon, etc. may be used. The dew point inside the hermetic space S2001 is, for example, equal to or lower than −30° C., and thus, no condensation forms inside the hermetic space S2001 under a temperature within a usage environment temperature (or operation guarantee temperature) of the illuminating device 2001. Besides, pressure of the dry gas inside the hermetic space S2001 is equal to or higher than that of the ambient air (that is, 1 atmospheric pressure or higher).

The present embodiment, as described above, is provided with the body 2020 constituting the hermetic space S2001 in which the fluorescent member 2005 is disposed, and a dry gas is sealed in the hermetic space S2001. Thereby, it is possible to prevent condensation in the hermetic space S2001, and thus, it is possible to prevent water droplets from sticking to the irradiated surface 2005a of the fluorescent member 2005, the laser-light-exit end surface 2004b of the light guide member 2004, etc. This makes it possible to reduce deviation of the laser light from the defined beam path caused by reflection or refraction of the laser light by water droplets. As a result, it is possible to reduce cases where desired illumination light fails to be obtained or cases where leaked laser light exerts harmful effects on human eyes.

Further, by disposing the fluorescent member 2005 inside the hermetic space S2001, it is possible to reduce degradation of the fluorescent member 2005 caused, for example, by moisture. For example, a sulfide fluorescent substance will deteriorate by moisture, and thus, this configuration is particularly effective in the case of a sulfide fluorescent substance.

Further, as described above, if the dry gas contains dry air or an inert gas, it is possible to easily prevent condensation inside the hermetic space S2001. Besides, with the dry gas sealed in the hermetic space S2001, the hermetic space S2001 is not a vacuum space, and this helps prevent the body 2020 from being crushed by the pressure from the ambient air. Furthermore, the pressure of the dry gas inside the hermetic space S2001 is equal to or higher than that of the ambient air (that is, 1 atmospheric pressure or higher). Thereby, it is possible to reduce inflow of the ambient air containing water vapor into the hermetic space S2001 in a case where it becomes impossible to maintain the hermeticity of the hermetic space S2001 (for example, in a case where a small pin hole is inadvertently formed in the body 2020).

Further, as described above, the dew point inside the hermetic space S2001 is equal to or lower than −30° C. In Japan, for example, the annual minimum temperature is very rarely below −30° C. Thus, the dew point of −30° C. or lower is sufficient to prevent condensation inside the hermetic space S2001.

Further, as described above, by providing the inlet 2007b in the body 2020 (the reflection member 2007), it is possible to easily allow the laser light emitted from the excitation light source 2002 into the hermetic space S2001.

Further, as described above, by providing the light guide member 2004, it is possible to easily guide the laser light emitted from the excitation light source 2002 into the hermetic space S2001.

Further, as described above, the light guide member 2004 is put through the inlet 2007b without a gap therebetween. Thereby, it is possible to insert the light guide member 2004 in the hermetic space S2001 while maintaining the hermeticity of the hermetic space S2001, and this makes it possible to easily allow the laser light emitted from the excitation light source 2020 into the hermetic space S2001.

Further, as described above, the defined beam path from the excitation light source 2002 to the laser-light-exit end surface 2004b of the light guide member 2004 is sealed up. Thereby, it is possible to prevent condensation in the defined beam path from the excitation light source 2002 to the laser-light-exit end surface 2004b of the light guide member 2004. Thereby, it is possible to prevent condensation anywhere in the defined beam path (the optical path of the laser light from the excitation light source 2002 to the fluorescent member 2005), and thus, it is possible to prevent deviation of the laser light from the defined beam path.

The temperature of a member having high heat conductivity drops faster than that of a member having low heat conductivity, and thus, condensation is liable to occur on a surface of a member having high heat conductivity. Typically, a metal member is provided around a fluorescent member for better heat dissipation, and thus, if a resin reflection member is used, condensation is liable to form around such a metal member. Assuming that the space in the configuration of the present embodiment is not hermetic, condensation is liable to occur on the surface of, for example, the support member 2006. Thus, there is a possibility that water droplets may flow from the metal member (support member 2006) to the fluorescent member 2005, where the water droplets will reflect laser light to deviate the laser light from the defined beam path. Furthermore, in a case where the reflection member 2007 is made of metal, condensation is liable to occur on an internal surface (the reflection surface 2007a) of the reflection member 2007. In this case, there is a possibility that water droplets sticking to the internal surface (the reflection surface 2007a) of the reflection member 2007 may drop down onto the fluorescent member 2005, where the water droplets will deviate the laser light from the defined beam path. According to the present embodiment, as described above, since it is possible to prevent condensation in the hermetic space S2001, even in a case where a member having high heat conductivity is provided, for example, around the fluorescent member 2005, it is possible to reduce deviation of the laser light from the defined beam path.

### Twelfth Embodiment

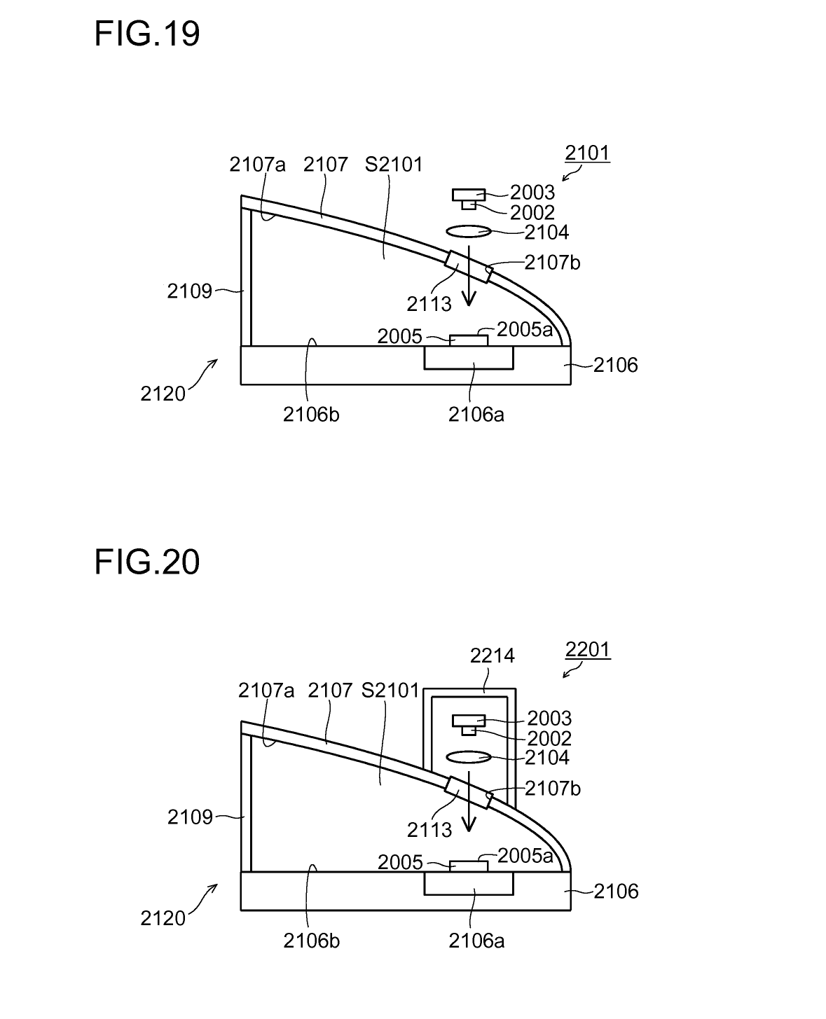

A twelfth embodiment will be described by dealing with a case where, as shown in FIG. 19, a light guide member 2104 is formed of a lens.

An illuminating device 2101 of the twelfth embodiment of the present invention includes an excitation light source 2002, a heat dissipation member 2003, a light guide member 2104 disposed anterior to the excitation light source 2002, a fluorescent member 2005, a support member 2106 that supports the fluorescent member 2005, a reflection member 2107 that outwardly reflects light emitted from the fluorescent member 2005, and a transmissive member 2109 (a first transmissive member) that transmits fluorescence and outwardly emits the fluorescence. In the present embodiment, the reflection member 2107, a later-described transmissive member 2113, the support member 2106, and the transmissive member 2109 together form a body 2120. Inside the body 2120, a hermetic space S2101 is formed.

The transmissive member 2104 is formed of a lens (for example, a biconvex lens). The light guide member 2104 is disposed outside the body 2120 (more specifically, outside the hermetic space S2101).

The support member 2106, which may be formed of metal, resin, etc., is formed such that at least part (a holding portion 2106a) of the support member 2106 around the fluorescent member 2005 is formed of a material having high heat conductivity such as metal. The holding portion 2106a is configured to dissipate heat generated at the fluorescent member 2005 to the entire support member 2106, an unillustrated metal member, etc. It is preferable that an internal surface 2106b (one of the surfaces that form the hermetic space S2101) of the support member 2106 be formed as a reflection surface that has a function of reflecting light.

The reflection member 2107 has a function of outwardly reflecting fluorescence emitted from the fluorescent member 2005. A reflection surface 2107a of the reflection member 2107 is formed such that the reflection surface 2107a includes, for example, a part of a paraboloid, and more specifically, the reflection surface 2107a is formed in a shape obtained by dividing a paraboloid by a plane that is parallel to an axis (a rotation axis of the paraboloid) connecting a vertex and a focal point of the paraboloid. Besides, at a predetermined position in the reflection member 2107, there is provided an inlet 2107b for allowing the laser light (the excitation light) emitted from the excitation light source 2002 into the hermetic space S2101.

The inlet 2107b is provided with a transmissive member 2113 (a second transmissive member) that transmits at least the laser light (the excitation light), and there is no gap between the inlet 2107b and the transmissive member 2113. The transmissive member 2113 is formed of, for example, inorganic glass such as quartz glass and others, resin, etc. Besides, the transmissive member 2113 may be configured to reflect fluorescence emitted from the fluorescent member 2005. With this configuration, it is possible to prevent the fluorescence from returning toward the excitation light source 2002 side, and thus, it is possible to improve light usage efficiency.

The transmissive member 2109 is, for example, a plate-shaped member formed of glass, resin, etc. The transmissive member 2109 may be formed of a lens. The transmissive member 2109 is fixed to the reflection member 2107 and to the support member 2106 without a gap therebetween.

The hermetic space S2101 is filled with a dry gas to prevent condensation. A seal member, for example, is provided at a boundary portion between two adjacent ones of the members constituting the hermetic space S2101 (for example, between a side surface of the transmissive member 2113 and an internal surface of the inlet 2107b), as necessary.

In other respects, the structure of the twelfth embodiment is similar to that of the eleventh embodiment described above.

In the present embodiment, as described above, the inlet 2107b is provided with the transmissive member 2113 that transmits the laser light, and there is no gap between the inlet 2107b and the transmissive member 2113. Thereby, it is possible to easily allow the laser light emitted from the excitation light source 2002 into the hermetic space S2101 while maintaining the hermeticity of the hermetic space S2101.

Further, as described above, the transmissive member 2113 may be formed of inorganic glass such as quartz glass and others. Inorganic glass such as quarts glass and others has higher heat conductivity than resin. Thus, if the space in the configuration of the present embodiment were not hermetic, condensation would be liable to occur on the internal surface of the transmissive member 2113. Thus, the laser light might be reflected or refracted by water droplets to be deviated from the defined beam path. According to the present embodiment, as described above, it is possible to prevent condensation in the hermetic space S2101, and thus, even in a case where a member having high heat conductivity is used as the transmissive member 2113, it is possible to reduce deviation of the laser light from the defined beam path.

Other advantages of the twelfth embodiment are similar to those of the eleventh embodiment described above.

### Thirteenth Embodiment

In an illuminating device 2201 of a thirteenth embodiment of the present invention, as shown in FIG. 20, unlike in the above-described twelfth embodiment, a cover member 2214 is provided to cover an excitation light source 2002 and a light guide member 2104. The cover member 2214 is attached to a reflection member 2107. The cover member 2214 has a function of blocking excitation light, and is formed of, for example, resin, metal, etc.

In other respects, the structure of the thirteenth embodiment is similar to that of the twelfth embodiment described above.

In the present embodiment, as described above, by providing the cover member 2214 that covers the excitation light source 2002, it is possible to easily prevent leakage of the laser light to outside the illuminating device 2201 even in a case where condensation has formed outside a hermetic space S2101 (for example, on a laser-light-entrance surface of a transmissive member 2113) to deviate the laser light from the defined beam path.

Other advantages of the thirteenth embodiment are similar to those of the twelfth embodiment described above.

The eleventh to thirteenth embodiments disclosed above are to be considered in all respects as illustrative and not restrictive. The scope of the present invention is set out in the appended claims and not in the description of the embodiments hereinabove, and includes any variations and modifications within the sense and scope equivalent to those of the claims.

For example, the foregoing descriptions of the eleventh to thirteenth embodiments have dealt with examples where illuminating devices of the present invention are applied to automobile headlamps, but this is not meant to limit the present invention. Illuminating devices of the present invention may be applied to headlamps of other moving bodies such as airplanes, ships, robots, motorcycles, bicycles, etc.

Further, the foregoing descriptions of the eleventh to thirteenth embodiments each have dealt with an example where an illuminating device of the present invention is applied to headlamps, but this is not meant to limit the present invention. Illuminating devices of the present invention may be applied to down lights, spot lights, and other illuminating devices. Further, illuminating devices of the present invention may be applied to illuminating devices having no reflection member such as electric light bulb-type illuminating devices.

Further, the foregoing descriptions of the eleventh to thirteenth embodiments each have dealt with an example where the excitation light is converted to visible light, but this is not meant to limit the present invention, and the excitation light may be converted to light other than visible light. For example, in a case where the excitation light is converted to infrared light, the illuminating devices of the present invention are also applicable to a nighttime illuminating device for a security CCD camera.

Further, the foregoing descriptions of the eleventh to thirteenth embodiments have dealt with examples where the excitation light source and the fluorescent member are configured such that white light is emitted, but this is not meant to limit the present invention. The excitation light source and the fluorescent member may be configured such that light of a color other than white is emitted.

Further, the foregoing descriptions of the eleventh to thirteenth embodiments each have dealt with an example where a semiconductor laser element is used as the excitation light source that emits laser light, but this is not meant to limit the present invention, and an excitation light source other than a semiconductor laser element may be used.

Further, the foregoing descriptions of the eleventh to thirteenth embodiments have dealt with examples where the reflection surface of the reflection member includes a part of a paraboloid, but this is not meant to limit the present invention, and the reflection surface may include, for example, a part of an ellipsoid. In this case, by positioning an irradiation area of the fluorescent member at the focal point of the reflection surface, it is possible to easily collect light emitted from the illuminating device. Further, the reflection surface may be a multi-reflecting surface composed of a large number of curved surfaces (for example, paraboloids), a freely-curved reflecting surface composed of a large number of minute flat surfaces that are continuously arranged, etc.

Further, the foregoing descriptions of the eleventh to thirteenth embodiments have dealt with examples where the dew point inside the hermetic space is equal to or lower than −30° C., but this is not meant to limit the present invention. As long as condensation does not occur at any temperature within the range of the usage environment temperature (or the operation guarantee temperature) of the illuminating device, the dew point inside the hermetic space may be, for example, equal to or lower than −10° C., equal to or lower than −20° C., or equal to or lower than −40° C.

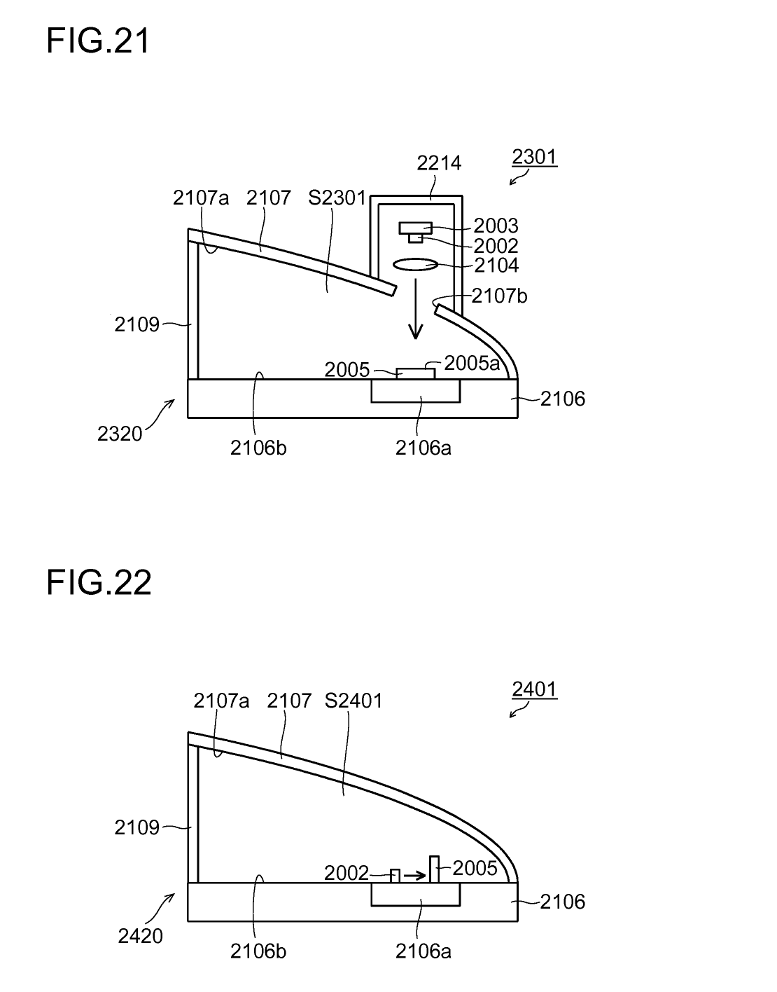

Further, for example, the foregoing description of the thirteenth embodiment has deal with a case where the cover member 2214 covers the excitation light source 2002 and the light guide member 2104, but this is not meant to limit the present invention. For example, the cover member 2214 may be fixed to the reflection member 2107 by using a seal member to make a space inside the cover member 2214 a hermetic space in which dry air, for example, is sealed. With this configuration, it is possible to dispose the excitation light source 2002 inside the hermetic space, and to seal up the optical path of the laser light from the excitation light source 2002 to the inlet 2107b. Thereby, it is possible to seal up all the optical path of the laser light (the defined beam path) from the excitation light source 2002 to the fluorescent member 2005, and to prevent condensation anywhere in the defined beam path, and thus, it is possible to prevent deviation of the laser light from the defined beam path. In the case that inside the cover member 2214 is formed as a hermetic space, unlike in an illuminating device 2301 of a fifth modified example of the present invention shown in FIG. 21, for example, there is no need of providing a transmissive member 2113. In this case, the reflection member 2107, the cover member 2214, the support member 2106, the transmissive member 2109, and the like together form a body 2320 which forms a hermetic space S2301 in which the excitation light source 2002 and the fluorescent member 2005 are disposed.

Further, the foregoing descriptions of the eleventh to thirteenth embodiments have dealt with examples where an optical fiber or a lens is used as the light guide member, but this is not meant to limit the present invention. A reflection mirror may be used as the light guide member, or, two or more from an optical fiber, a lens, a reflection mirror, etc. may be used in combination as the light guide member. Note that the light guide member is provided as necessary, and it does not need to be provided in a case where the excitation light source 2002 is disposed near the fluorescent member 2005 like, for example, in an illuminating device 2401 of a sixth modified example of the present invention shown in FIG. 22. In the illuminating device 2401, a reflection member 2107, a support member 2106, a transmissive member 2109, and the like together form a body 2420 that constitutes a hermetic space S2401 in which the excitation light source 2002 and the fluorescent member 2005 are disposed. Since the excitation light source 2002 is disposed inside the hermetic space S2401, it is possible, like in the illuminating device 2301 described above, to prevent condensation anywhere in the defined beam path. Thereby, it is possible to reduce deviation of the laser light from the defined beam path.

Further, the foregoing descriptions of the eleventh to thirteenth embodiments have dealt with examples where a dry gas is sealed in the hermetic space, but this is not meant to limit the present invention, and the hermetic space may be a vacuum space. In this case as well, it is possible to easily prevent condensation in the hermetic space.

It should be understood that configurations obtained by appropriately combining the configurations of the foregoing embodiments and modified examples are also included in the scope of the present invention.

### Fourteenth Embodiment

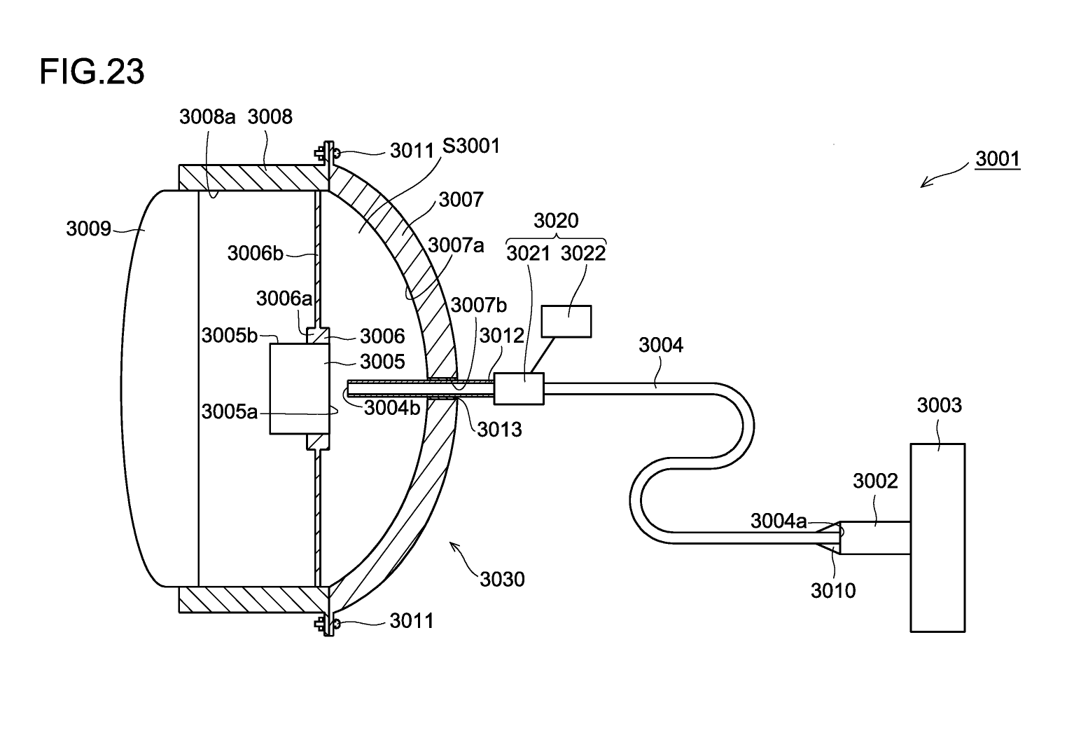

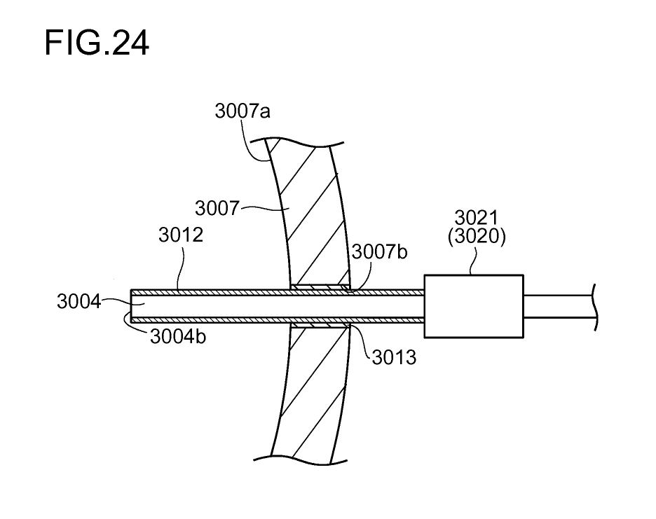

A description will be given of a structure of an illuminating device 3001 of a fourteenth embodiment of the present invention with reference to FIGS. 23 and 24.

The illuminating device 3001 of the fourteenth embodiment of the present invention is one that is used as a headlamp that illuminates an area ahead of, for example, an automobile. As shown in FIG. 23, the illuminating device 3001 includes an excitation light source 3002 that emits laser light functioning as excitation light, a heat dissipation member 3003 to which the excitation light source 3002 is fixed, a light guide member 3004 disposed anterior to the excitation light source 3002, a fluorescent member 3005 that is irradiated with the laser light (the excitation light), a support member 3006 that supports the fluorescent member 3005, a reflection member 3007 that reflects fluorescence, which is emitted from the fluorescent member 3005, toward outside the illuminating device 3001, a bezel 3008 that is fixed to a front edge of the reflection member 3007, a transmissive member 3009 that transmits the fluorescence and emits the fluorescence to outside the illuminating device 3001, and an anti-condensation unit 3020 (a first anti-condensation unit) that removes condensation on a laser-light-passing surface. In the present embodiment, the reflection member 3007, the bezel 3008, the transmissive member 3009, and the like together form a body 3030. Inside the body 3030, a hermetic space S3001 is formed.

Note that the laser-light-passing surface means a surface through which laser light passes, and in the present embodiment, a laser-light-exit surface of the excitation light source 3002, a laser-light-entrance surface 3004a and a laser-light-exit surface 3004b of the light guide member 3004, and an irradiated surface 3005a of the fluorescent member 3005 are laser-light-passing surfaces. Besides, in the present embodiment, the anti-condensation unit 3020 removes condensation on the laser-light-exit surface 3004b of the light guide member 3004 among the laser-light-passing surfaces mentioned above.

The excitation light source 3002 is a semiconductor laser, and configured with a semiconductor laser element (not shown) and a package in which the semiconductor laser element is mounted. The excitation light source 3002 is configured to emit laser light having, for example, a center wavelength of approximately 380 nm-approximately 460 nm. The excitation light source 3002 is disposed outside the body 3030.

The heat dissipation member 3003 is formed of, for example, a metal block, and has a function of dissipating heat generated in the excitation light source 3002. The heat dissipation member 3003 is provided as necessary, and one of the existing members may be used as a substitute for the heat dissipation member 3003.

The light guide member 3004 has a function of guiding the laser light emitted from the excitation light source 3002 to the fluorescent member 3005. In the present embodiment, the light guide member 3004 is formed of, for example, an optical fiber.

A laser-light-entrance surface 3004a side part of the light guide member 3004 is fixed to the excitation light source 3002. A fixation member 3010 is provided in such a manner that the fixation member 3010 seals the laser-light-entrance surface 3004a of the light guide member 3004 and the laser-light-exit surface of the excitation light source 3002. A connection portion between the light guide member 3004 and the excitation light source 3002 is formed such that no condensation is allowed in an optical path of the laser light. For example, a transparent fixation member 3010 may be provided between the laser-light-entrance surface 3004a of the light guide member 3004 and the laser-light-exit surface of the excitation light source 3002. Besides, the light guide member 3004 may be a pigtail fiber such that the light guide member 3004 and the excitation light source 3002 are pigtail-connected to each other. In this case as well, it is possible for the laser-light-entrance surface 3004a of the light guide member 3004 and the laser-light-exit surface of the excitation light source 3002 to be hermetic, and to prevent condensation in the optical path of the laser light in the connection portion between the light guide member 3004 and the excitation light source 3002. In the present specification, to be hermetic means to be sealed to be impervious to gas.

A laser-light-exit surface 3004b side part of the light guide member 3004 is put through a later-described inlet 3007b of the reflection member 3007, and the laser-light exit surface 3004b is disposed inside the body 3030. It is preferable that the light guide member 3004 be put through the inlet 3007b without a gap therebetween.

Besides, the laser-light-exit surface 3004b is disposed a predetermined distance away from an irradiated surface 3005a of the fluorescent member 3005 that is irradiated with the laser light. This makes it possible to reduce re-entrance of light coming from the irradiated surface 3005a of the fluorescent member 3005 into the light guide member 3004 through the laser-light-exit surface 3004b, and thus, it is possible to reduce degradation of light usage efficiency.

The fluorescent member 3005 is disposed inside the body 3030, and has a function of emitting fluorescence by being irradiated with the laser light (the excitation light). In addition, the fluorescent member 3005 emits fluorescence having a center wavelength that is longer than the wavelength of the excitation light. The fluorescent member 3005 includes three kinds of fluorescent substances (not shown) that respectively convert blue-violet laser light into red light, green light, and blue light. The red light, the green light, and the blue light emitted from the fluorescent member 3005 are mixed together, and thereby, white illumination light is obtained. Note that the fluorescent member 3005 may include just one kind of fluorescent substance that converts, for example, part of blue laser light into yellow light. And white illumination light may be obtained by mixing the yellow light with the blue light scattered by the fluorescent member 3005. The fluorescent member 3005 may be, for example, one that is made by mixing a fluorescent substance with glass, resin, etc. and forming the mixture into a lump, or one that is made by applying pressure to, or sintering, fluorescent particles.

The support member 3006 includes a holding portion 3006a that holds a side surface 3005b of the fluorescent member 3005 and a plurality of rod-shaped fitting portions 3006b that are fitted to the bezel 3008. The holding portion 3006a may hold the side surface of the fluorescent member 3005 either directly or indirectly via, for example, a bonding layer. The fitting portions 3006b may be fitted to the reflection member 3007.

Further, the support member 3006 is formed of a highly heat conductive material such as metal, graphite, etc. The support member 3006 is configured to dissipate heat generated at the fluorescent member 3005 to the bezel 3008, the reflection member 3007, an unillustrated metal block, etc.

The reflection member 3007 has a function of outwardly reflecting light (fluorescence and scattered light) emitted from the fluorescent member 3005. A reflection surface 3007a of the reflection member 3007 is formed concave such that the reflection surface 3007a includes, for example, a part of a paraboloid. In addition, the irradiated surface 3005a of the fluorescent member 3005 is located in an area that includes a focal point of the reflection surface 3007a. At a predetermined position in the reflection member 3007 (for example, at a vertex of the reflection member 3007), the inlet 3007b is provided to allow the laser light (the excitation light) emitted from the excitation light source 3002 into the hermetic space S3001. The reflection member 3007 is formed of metal, resin, etc. In a case where the reflection member 3007 is formed of resin, the reflection surface 3007a may be formed of, for example, a metal film.

The bezel 3008 is formed, for example, in a cylindrical shape, and fixed to the front edge of the reflection member 3007 with bolts 3011 or screws (not shown). The bezel 3008 is formed of metal, resin, etc. It is preferable that an internal surface 3008a of the bezel 3008 is formed as a reflection surface that has a function of reflecting light.

The transmissive member 3009 is formed of a lens (for example, a planoconvex lens) made of glass, resin, etc. The transmissive member 3009 is fixed to the internal surface 3008a of the bezel 3008 without a gap therebetween. Between an external surface of the transmissive member 3009 and the internal surface 3008a of the bezel 3008, there may be provided an unillustrated bonding member.

The anti-condensation unit 3020 is configured to perform a preliminary operation of removing condensation on the laser-light-exit surface 3004b (a laser-light-passing surface) of the light guide member 3004 (a member disposed in the optical path of the laser light) before the excitation light source 3002 performs a principal operation. Note that the principal operation of the excitation light source 3002 is an operation in which the excitation light source 3002 emits laser light to obtain desired illumination light. The anti-condensation unit 3020 includes a heater 3021 that has a heating function, and a controller 3022 that controls an operation of the heater 3021.

Here, as shown in FIGS. 23 and 24, the light guide member 3004 has a heat conductive layer 3012 (a heat conductive portion) that is formed on an external surface thereof on the laser-light-exit surface 3004b side. The heat conductive layer 3012 extends to the laser-light-exit surface 3004b. Also, the heat conductive layer 3012 is connected to the heater 3021, and has a function of transferring heat generated by the heater 3021 to the laser-light-exit surface 3004b.

The heat conductive layer 3012 may be a metal wire mesh, or the heat conductive layer 3012 may be an electrically conductive film formed on the surface of the light guide member 3004. Between an external surface of the heat conductive layer 3012 and an internal surface of the inlet 3007b of the reflection member 3007, there is provided an insulating member 3013 formed of, for example, resin. With this configuration, it is possible to reduce escape of heat from the heat conductive layer 3012 to the reflection member 3007.

There may further be provided a coating (not shown) of, for example, an insulating resin to cover the external surface of the heat conductive layer 3012. With this configuration, it is possible to prevent the heat conductive layer 3012 from being corroded by, for example, water droplets. The insulating member 3013 is not indispensable in a case where the external surface of the heat conductive layer 3012 is coated with, for example, an insulating resin, or in a case where the reflection member 3007 is formed of, for example, resin.

The heater 3021 is preferably disposed close to the laser-light-exit surface 3004b of the light guide member 3004. With this configuration, it is possible to transfer heat generated by the heater 3021 quickly to the laser-light-exit surface 3004b. The heater 3021 may be disposed inside the body 3030, but, for the purpose of preventing absorption of light by the heater 3021 or reflection of light by the heater 3021 toward unexpected directions, it is preferable to dispose the heater 3021 outside the body 3030.

The controller 3022 is, as shown in FIG. 23, connected to the heater 3021 via an unillustrated power supply portion, and the controller 3022 is configured to control an operation (turning on/off) of the heater 3021. Besides, the controller 3022 is connected, as necessary, to an engine-start switch, a door-lock switch, a door opening/closing switch or a door opening/closing detection sensor, a bonnet switch (or an engine-hood switch), etc. of an automobile. The controller 3022 is configured to turn on the heater 3021 (start the preliminary operation), for example, when a driver turns on the engine, when a driver sits on the driver's seat and locks the doors, when a driver unlocks the doors to ride in the automobile, when the driver-side door is opened with the doors unlocked, or when a driver or an operator opens the bonnet (or the engine hood) for a maintenance purpose.

Further, the controller 3022 is connected, as necessary, to a timer, a temperature sensor for measuring the outside air temperature, a temperature sensor for measuring temperature inside the body 3030, etc. For example, the controller 3022 may be configured to turn off the heater 3021 (finish the preliminary operation) when a predetermined length of time (for example, on the order of several seconds to ten seconds) has passed. Besides, the controller 3022 may be configured to turn off the heater 3021 when the temperature inside the body 3030 reaches or exceeds a predetermined temperature (for example, 20° C. to 30° C.). Besides, the controller 3022 may be configured to turn off the heater 3021 when the temperature inside the body 3030 reaches a temperature that is higher than the outside air temperature by a predetermined value (for example, by approximately 5° C. to 10° C.). That is, the heater 3021 may be configured to perform the preliminary operation for a predetermined length of time. Besides, the heater 3021 may be configured to continue the preliminary operation until temperature around the laser-light-exit surface 3004b reaches a predetermined temperature. Besides, the heater 3021 may be configured to continue the preliminary operation until the temperature around the laser-light-exit surface 3004b exceeds the outside air temperature by a predetermined amount or more.

Further, the controller 3022 may be connected, as necessary, to a humidity sensor for measuring relative humidity inside the body 3030, a water-drop detection sensor for detecting water droplets on the laser-light-exit surface 3004b of the light guide member 3004, etc. Here, the controller 3022 may be configured to turn off the heater 3021 when the relative humidity inside the body 3030 drops to or below 95%, for example. The controller 3022 may also be configured to turn off the heater 3021 when water droplets on the laser-light-exit surface 3004b have disappeared.

Note that, even in a case where, for example, a driver has turned on the engine, if the above-listed conditions for turning off the heater 3021 are satisfied, the heater 3021 does not need to be turned on. That is, in a case where no condensation has been formed on the laser-light-exit surface 3004b, the preliminary operation does not need to be performed.

The excitation light source 3002 is configured such that it does not start the principal operation until the preliminary operation of the anti-condensation unit 3020 is finished. The controller 3022 may be configured such that it controls an operation of the excitation light source 3002 as well.

The present embodiment, as described above, includes the anti-condensation unit 3020 that performs the preliminary operation of removing condensation on the laser-light-exit surface 3004b of the light guide member 3004 that is disposed in the optical path of the laser light, before the excitation light source 3002 performs the principal operation. Thereby, it is possible to make the excitation light source 3002 perform the principal operation after the preliminary operation of removing condensation on the laser-light-exit surface 3004b is performed. Thus, it is possible to reduce deviation of the laser light from the defined beam path caused by reflection or refraction of the laser light in an unintended direction by water droplets on the laser-light-exit surface 3004b. As a result, it is possible to reduce cases where desired illumination light is not able to be obtained or where laser light leaks out of the illuminating device 3001 to exert harmful effects on human eyes.

Further, it is possible to remove condensation on the laser-light-exit surface 3004b of the light guide member 3004, to thereby reduce deviation of laser light from the defined beam path before it reaches the fluorescent member 3002, and this is particularly advantageous.

Further, as described above, the anti-condensation unit 3020 includes the heater 3021 for heating the laser-light-exit surface 3004b. Thereby, it is possible to easily remove condensation on the laser-light-exit surface 3004b.

Further, as described above, the light guide member 3004 is provided to guide the laser light emitted from the excitation light source 3002 to the fluorescent member 3005. Thereby, it is possible to easily guide the laser light emitted from the excitation light source 3002 to the fluorescent member 3005.

Further, as described above, the light guide member 3004 has, on a surface thereof, the heat conductive layer 3012 that transfers heat generated by the heater 3021 to the laser-light-exit surface 3004b of the light guide member 3004. Thereby, it is possible to easily transfer the heat generated by the heater 3021 to the laser-light-exit surface 3004b of the light guide member 3004. Thereby, it is possible to easily remove condensation on the laser-light-exit surface 3004b.

Further, as described above, by providing the inlet 3007b in the reflection member 3007, it is possible to easily allow the laser light emitted from the excitation light source 3002 into the body 3030.

Further, as described above, the heater 3021 may continue the preliminary operation for the predetermined length of time. Besides, the heater 3021 may continue the preliminary operation until the temperature around the laser-light-exit surface 3004b reaches the predetermined temperature. Besides, the heater 3021 may continue the preliminary operation until the temperature around the laser-light-exit surface 3004b exceeds the outside air temperature by the predetermined amount or more. In whichever case, it is possible to easily remove condensation on the laser-light-exit surface 3004b.

Further, as described above, by putting the light guide member 3004 through the inlet 3007b without a gap therebetween, it is possible to prevent dust or the like from entering the body 3030 through the inlet 3007b. Thereby, it is possible to reduce deviation of the laser light from the defined beam path caused by the laser light hitting dust or the like.

Further, as described above, the anti-condensation unit 3020 starts the preliminary operation in association with door locking, door unlocking, door opening/closing, etc. Thereby, it is possible to remove condensation before a driver turns on the illuminating device 3001, and this is particularly advantageous.

### Fifteenth Embodiment

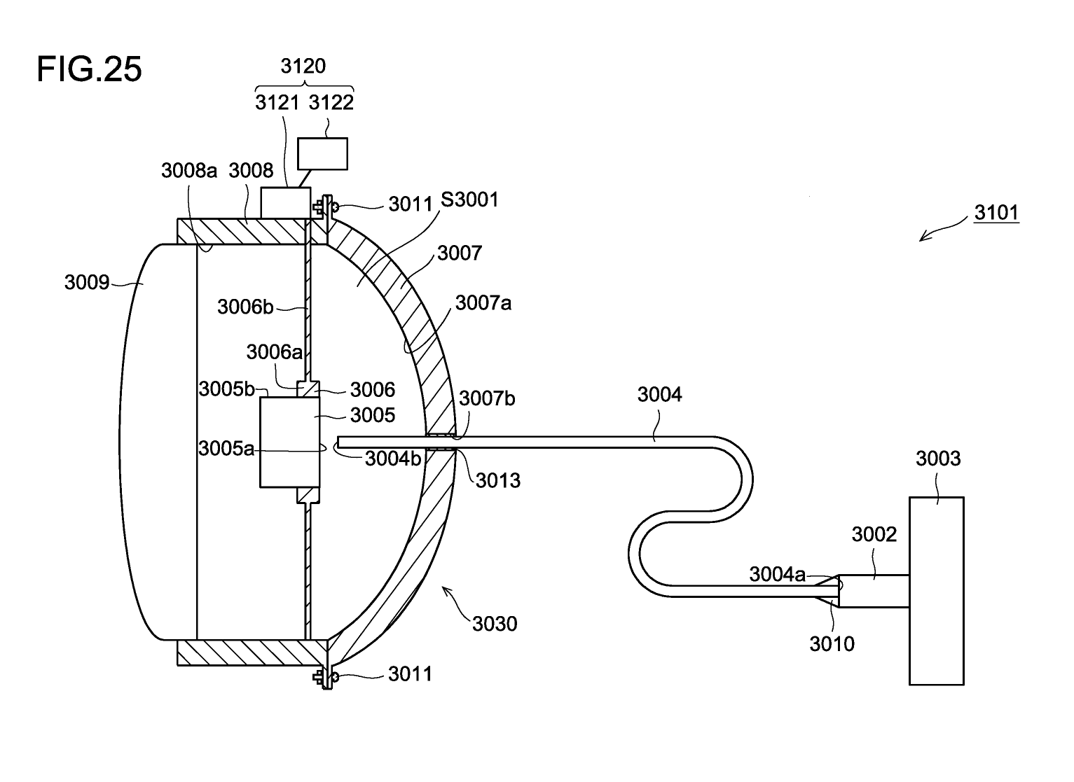

As shown in FIG. 25, an illuminating device 3101 of a fifteenth embodiment of the present invention is provided with an anti-condensation unit 3120 (a first anti-condensation unit) which includes a heater 3121 having a heating function, and a controller 3122 that controls an operation of the heater 3121. In the present embodiment, the anti-condensation unit 3120 is configured to perform a preliminary operation of removing condensation on an irradiated surface 3005a (a laser-light-passing surface) of a fluorescent member 3005 (a member disposed in an optical path of laser light) before an excitation light source 3002 performs a principal operation.

The heater 3121 has a function of heating the fluorescent member 3005. The heater 3121 is thermally connected to fitting portions 3006b of a support member 3006, and heat generated by the heater 3121 is transferred via the support member 3006 to the fluorescent member 3005.

The controller 3122 is configured similar to the controller 3022 of the above-described fourteenth embodiment. For example, the controller 3122 may be connected, as necessary, to a humidity sensor for measuring relative humidity inside a body 3030, a water-drop detection sensor for detecting water droplets on the irradiated surface 3005a of the fluorescent member 3005, etc. And, the controller 3122 may be configured to turn off the heater 3121 when the relative humidity inside the body 3030 drops to or below 95%, for example. Besides, the controller 3122 may be configured to turn off the heater 3121 when water droplets on the irradiated surface 3005a have disappeared.

In other respects, the structure of the fifteenth embodiment is similar to that of the fourteenth embodiment described above.

In the present embodiment, as described above, the anti-condensation unit 3120 removes water droplets on the irradiated surface 3005a of the fluorescent member 3005. Thereby, it is possible to reduce deviation of the laser light from a defined beam path caused by reflection of the laser light by water droplets on the irradiated surface 3005a of the fluorescent member 3005.

The temperature of a member having high heat conductivity drops faster than that of a member having low heat conductivity, and thus, condensation is liable to occur on a surface of a member having high heat conductivity. In the present embodiment, the support member 3006 disposed near the fluorescent member 3005 has high heat conductivity for efficient heat dissipation, and thus condensation is liable to occur around the support member 3006. Thus, there is a possibility that water droplets may flow from the support member 3006 to the fluorescent member 3005 to reflect laser light such that the laser light will deviate from the defined beam path. Furthermore, in a case where a metal reflection member 3007 is used, condensation is liable to occur on an internal surface (a reflection surface 3007a) of the reflection member 3007. In this case, there is a possibility that water droplets sticking to the internal surface (the reflection surface 3007a) of the reflection member 3007 may drop down onto the fluorescent member 3005, where the water droplets deviate the laser light from the defined beam path. According to the present embodiment, as described above, since it is possible to remove condensation on the irradiated surface 3005a of the fluorescent member 3005, even in a case where a member having high heat conductivity is used, for example, around the fluorescent member 3005, it is possible to reduce deviation of the laser light from the defined beam path.

Other advantages of the fifteenth embodiment are similar to those of the fourteenth embodiment described above.

### Sixteenth Embodiment

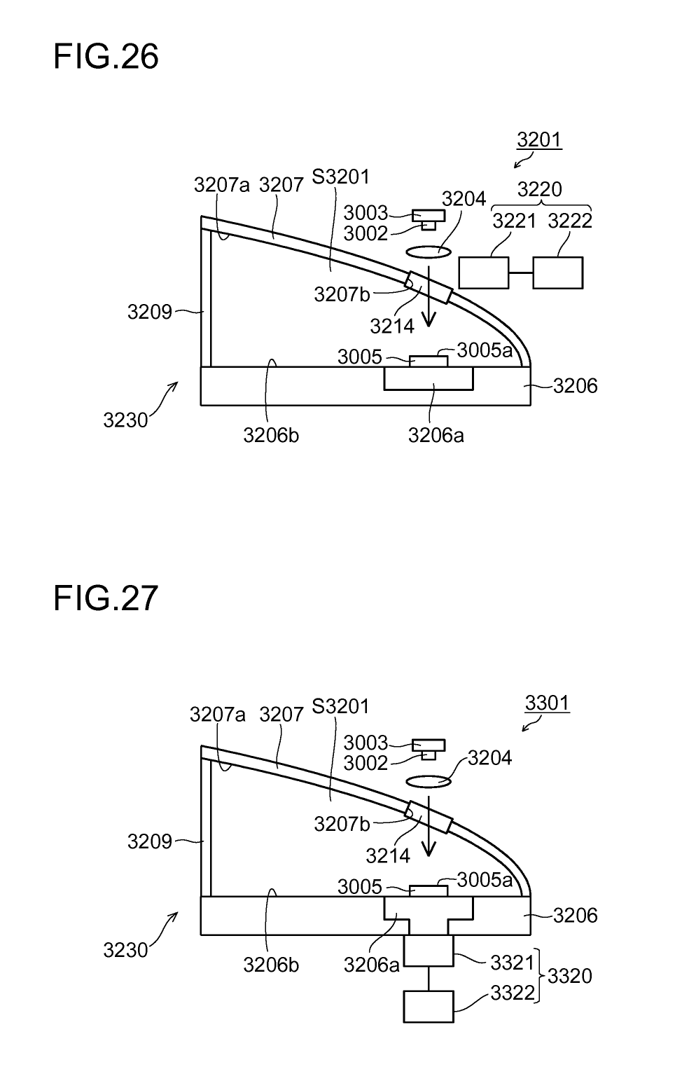

A sixteenth embodiment will be described by dealing with a case where, as shown in FIG. 26, a light guide member 3204 is formed of a lens.

An illuminating device 3201 of the sixteenth embodiment of the present invention includes an excitation light source 3002, a heat dissipation member 3003, a light guide member 3204 disposed anterior to the excitation light source 3002, a fluorescent member 3005, a support member 3206 that supports the fluorescent member 3005, a reflection member 3207 that outwardly reflects light emitted from the fluorescent member 3005, a transmissive member 3209 that transmits fluorescence and emits the fluorescence to outside the illuminating device 3201, and an anti-condensation unit 3220 (a first anti-condensation unit) that removes condensation on a laser-light-passing surface. In the present embodiment, the reflection member 3207, a later-described transmissive member 3214, the support member 3206, and the transmissive member 3209 together form a body 3230. Inside the body 3230, a space S3201 is formed. In the present embodiment, a laser-light-exit surface of the excitation light source 3002, a laser-light-entrance surface and a laser-light-exit surface of the light guide member 3204, a laser-light-entrance surface and a laser-light-exit surface of the later-described transmissive member 3214, and an irradiated surface 3005a of the fluorescent member 3005 are laser-light-passing surfaces.

The transmissive member 3204 is formed of a lens (for example, a biconvex lens). The light guide member 3204 is disposed outside the body 3230.

Although the support member 3206 may be formed of metal, resin, etc., the support member 3206 is formed such that at least part (a holding portion 3206a) of the support member 3206 around the fluorescent member 3005 is formed of a material having high heat conductivity such as metal. The holding portion 3206a is configured to dissipate heat generated at the fluorescent member 3005 to the entire support member 3206, an unillustrated metal member, etc. It is preferable that an internal surface 3206b (one of the surfaces that form the space S3201) of the support member 3206 be formed with a reflection surface having a function of reflecting light.

The reflection member 3207 has a function of reflecting fluorescence, which is emitted from the fluorescent member 3005, toward outside the illuminating device 3201. A reflection surface 3207a of the reflection member 3207 includes, for example, a part of a paraboloid, and more specifically, the reflection surface 3207a is formed in a shape obtained by dividing a paraboloid by a plane that is parallel to an axis (a rotation axis of the paraboloid) connecting a vertex and a focal point of the paraboloid. Besides, at a predetermined position in the reflection member 3207, there is provided an inlet 3207b for allowing the laser light (the excitation light) emitted from the excitation light source 3002 into the space S3201.

The inlet 3207b is provided with the transmissive member 3214 (a third light-passing member) which transmits at least the laser light (the excitation light). The transmissive member 3214 is formed of, for example, inorganic glass such as quartz glass and others, resin, etc. Besides, the transmissive member 3214 may be configured to reflect fluorescence emitted from the fluorescent member 3005. With this configuration, it is possible to prevent the fluorescence from returning toward the excitation light source 3002 side, and thus, it is possible to improve light usage efficiency.

The transmissive member 3209 is formed of glass, resin, etc. formed in a plate shape. The transmissive member 3209 may be formed of a lens. The transmissive member 3209 is fixed to the reflection member 3207 and the support member 3206.

The anti-condensation unit 3220 includes a heater 3221 having a heating function, and a controller 3222 that controls an operation of the heater 3221.

The heater 3221 has a function of heating the transmissive member 3214. The heater 3221 and the transmissive member 3214 may be thermally connected to each other via a heat conductive member (not shown) to transfer heat generated by the heater 3221 to the transmissive member 3214. Besides, a blower may be provided close to the heater 3221 such that heat generated by the heater 3221 is blown to heat a surface (a laser-light-passing surface) of the transmissive member 3214.

The heater 3221 may be configured to heat the surfaces (the laser-light-entrance and laser-light-exit surfaces) of not only the transmissive member 3214 but also the transmissive member 3204, and the laser-light-exit surface of the excitation light source 3002 as well. Alternatively, the heater 3221 may be configured to heat only the surface of the light guide member 3204 or the laser-light-exit surface of the excitation light source 3002. This is because which part of the illuminating device 3201 is prone to condensation depends on the structure, material, location, and the like of the illuminating device 3201.

The controller 3222 is configured similar to the controllers of the above-described embodiments. For example, the controller 3222 may be connected, as necessary, to a humidity sensor for measuring relative humidity inside the body 3230, a water-drop detection sensor for detecting water droplets on the surfaces (the laser-light-entrance and laser-light-exit surfaces) of the light guide member 3214, etc. Here, the controller 3222 may be configured to turn off the heater 3221 when the relative humidity inside the body 3230 drops to or below 95%, for example. Besides/Alternatively, the controller 3222 may be configured to turn off the heater 3221 when water droplets on the irradiated surface 3005a have disappeared.

In other respects, the structure of the sixteenth embodiment is similar to that of the fourteenth embodiment described above.

In the present embodiment, as described above, the anti-condensation unit 3220 removes condensation on surfaces (laser-light-passing surfaces) of the transmissive member 3214, the light guide member 3204, etc. Thereby, it is possible to reduce deviation of the laser light from the defined beam path before the laser light reaches the fluorescent member 3005, and this is particularly advantageous.

Furthermore, as described above, the inlet 3207b is provided with the transmissive member 3214 that transmits laser light. Thereby, it is possible to prevent entry of dust or the like into the body 3230 through the inlet 3207b. Thereby, it is possible to reduce deviation of the laser light from the defined beam path caused by the laser light hitting dust or the like.

As described above, the transmissive member 3214 may be formed of inorganic glass such as quartz glass and others. Inorganic glass such as quarts glass and others has higher heat conductivity than resin. Thus, the surface of the transmissive member 3214 is prone to condensation. According to the present embodiment, as described above, it is possible to remove condensation on the surfaces of the transmissive member 3214, and thus, even in a case where a member having high heat conductivity is used, for example, as the transmissive member 3214, it is possible to reduce deviation of the laser light from a defined beam path.

Other advantages of the sixteenth embodiment are similar to those of the fourteenth embodiment described above.

### Seventeenth Embodiment

As shown in FIG. 27, an illuminating device 3301 of a seventeenth embodiment of the present invention is provided with an anti-condensation unit 3320 (a first anti-condensation unit) that includes a heater 3321 having a heating function, and a controller 3322 that controls an operation of the heater 3321. In the present embodiment, the anti-condensation unit 3320 is configured to perform a preliminary operation of removing condensation on an irradiated surface 3005a (a laser-light-passing surface) of a fluorescent member 3005 before an excitation light source 3002 performs the principal operation.

The heater 3321 has a function of heating the fluorescent member 3005. The heater 3321 is thermally connected to a holding portion 3206a of a support member 3206, and heat generated by the heater 3321 is transferred via the support member 3206 to the fluorescent member 3005.

The controller 3322 is configured similar to the controllers of the above-described embodiments.

In other respects, the structure of the seventeenth embodiment is similar to that of the sixteenth embodiment described above.

Other advantages of the third embodiment are similar to those of the above-described fifteenth and sixteenth embodiments.

### Eighteenth Embodiment

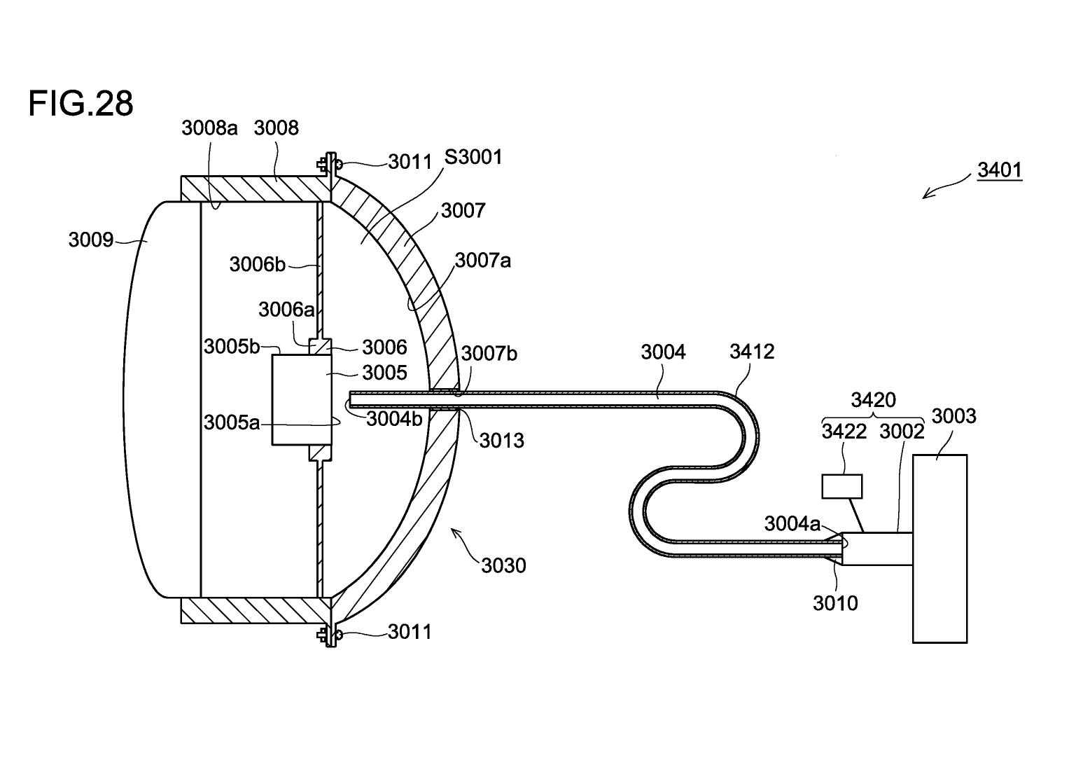

In an illuminating device 3401 of an eighteenth embodiment of the present invention, as shown in FIG. 28, a heat conductive layer 3412 (a heat conductive portion) extends from a laser-light-exit surface 3004b to a laser-light-entrance surface 3004a of a light guide member 3004.

In the present embodiment, an excitation light source 3002 serves also as a heater, and the excitation light source 3002 and a controller 3422 form an anti-condensation unit 3420 (a first anti-condensation unit).

The controller 3422 is connected to the excitation light source 3002 via an unillustrated power supply portion, and the controller 3422 is configured to control preliminary and principal operations of the excitation light source 3002. Besides, the controller 3422 controls the excitation light source 3002 such that the power of the excitation light source is sufficiently lower in a preliminary operation than in a principal operation. In the present embodiment, laser light is emitted from the excitation light source 3002 with condensation formed in a defined beam path; however, since the power of the excitation light source 3002 in the preliminary operation is sufficiently low, even if part of the laser light deviates from the defined beam path, it is possible to sufficiently prevent the deviated part of the laser light from exerting harmful effects on human eyes.

In other respects, the structure of the eighteenth embodiment is similar to that of the fourteenth embodiment described above.

In the present embodiment, as described above, the excitation light source 3002 serves also as the heater, and thus, there is no need of separately providing a heater, and this helps reduce the number of components and make the illuminating device 3401 compact. In addition, since the power of the excitation light source 3002 is lower in the preliminary operation than in the principal operation, it is possible to prevent high-power laser light from leaking out of the illuminating device 3401 while the preliminary operation is performed by using the excitation light source 3002.

Other advantages of the eighteenth embodiment are similar to those of the fourteenth embodiment described above.

### Nineteenth Embodiment

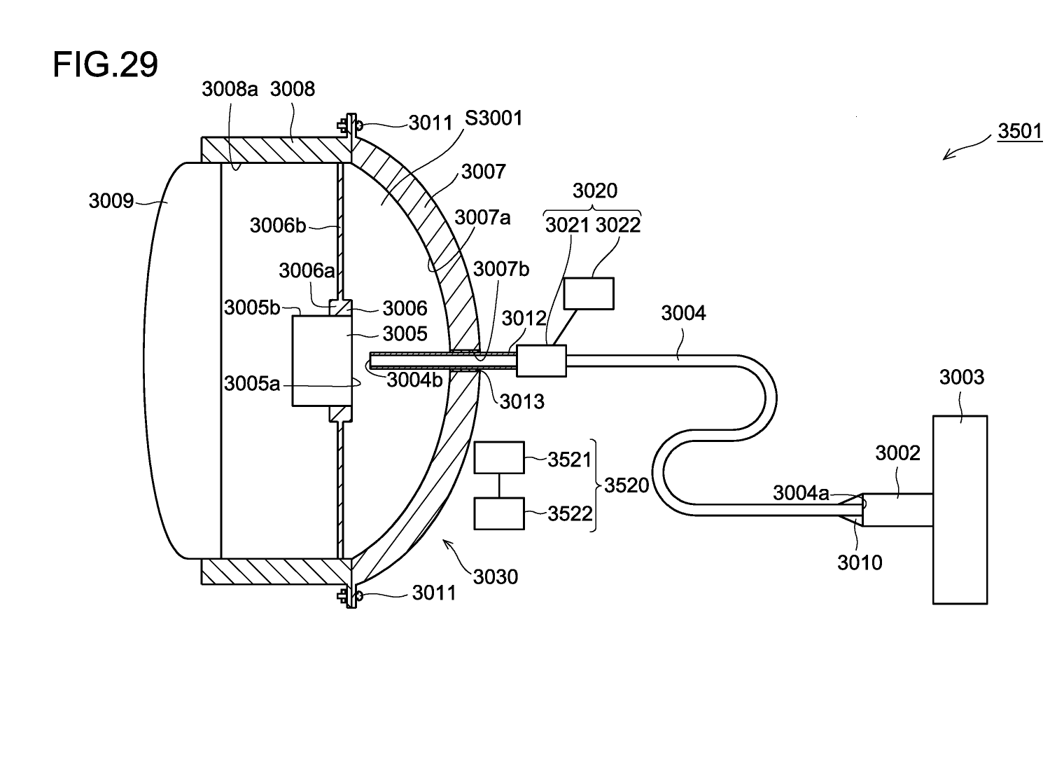

As shown in FIG. 29, an illuminating device 3501 of a nineteenth embodiment of the present invention is provided with an anti-condensation unit 3520 (a second anti-condensation unit) that includes a heater 3521 having a heating function, and a controller 3522 that controls an operation of the heater 3521.

The heater 3521 has a function of heating a reflection surface 3007a of a reflection member 3007. In a case where the reflection member 3007 is made of metal, it is possible to heat the reflection surface 3007a by heating the external surface of the reflection member 3007. In a case where the reflection member 3007 is made of resin, for example, by forming the reflection surface 3007a of a metal film and disposing the heater 3521 such that heat is able to be transferred to the metal film, it is possible to heat the reflection surface 3007a.

The controller 3522 is configured similar to the controllers of the above-described embodiments. For example, the anti-condensation unit 3520 is configured such that the anti-condensation unit 3520 performs the preliminary operation of removing condensation on the reflection surface 3007a of the reflection member 3007 before the excitation light source 3002 performs the principal operation. Here, since the laser light that would exert harmful effects on human eyes does not reach the reflection surface 3007a of the reflection member 3007, the operation of the anti-condensation unit 3520 and the principal operation of the excitation light source 3002 may be started simultaneously.

The anti-condensation unit 3520 may be configured to heat a bezel 3008 and a transmissive member 3009 (a fourth transmissive member) as well; the anti-condensation unit 3520 may be configured to heat not the reflection member 3007 but the bezel 3008, or the transmissive member 3009 alone. Besides, an anti-condensation unit 3020 may serve also as the anti-condensation unit 3520. In this case, it is possible to reduce a number of components, and to make the illuminating device 3501 compact.

In other respects, the structure of the nineteenth embodiment is similar to that of the fourteenth embodiment described above.

The present embodiment, as described above, is provided with the anti-condensation unit 3520 that removes condensation on the surfaces of the reflection member 3007, the transmissive member 3009, etc. Thereby, it is possible to prevent fluorescence from being reflected or refracted by water droplets on the surfaces of the reflection member 3007, the transmissive member 3009, etc., and thus to reduce cases where desired illumination light is not able to be obtained.

Other advantages of the nineteenth embodiment are similar to those of the fourteenth embodiment described above.

### Twentieth Embodiment

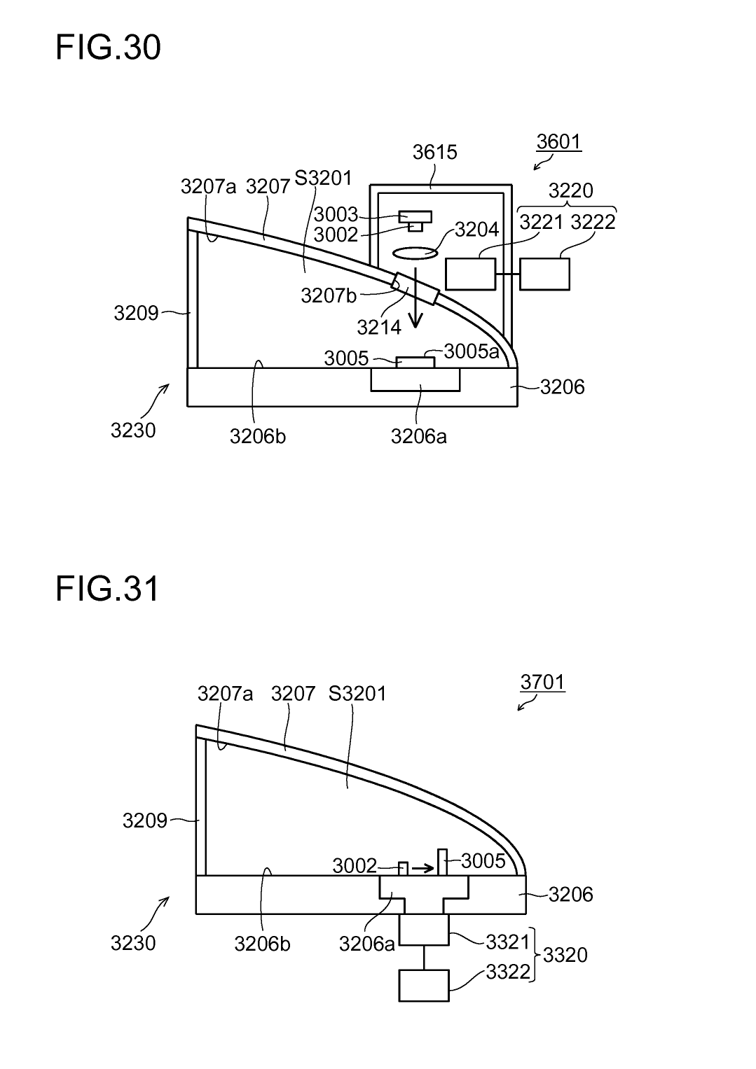

In an illuminating device 3601 of a twentieth embodiment of the present invention, as shown in FIG. 30, a cover member 3615 is provided to cover an excitation light source 3002 and a light guide member 3204. The cover member 3615 is attached to a reflection member 3207. The cover member 3615 has a function of blocking excitation light, and is formed of, for example, resin, metal, etc. A controller 3222 may be disposed outside the cover member 3615, or may be disposed inside the cover member 3615.

In other respects, the structure of the twentieth embodiment is similar to that of the sixteenth embodiment described above.

In the present embodiment, as described above, by providing the cover member 3615 for covering the excitation light source 3002 and the light guide member 3204, it is possible to easily prevent laser light from leaking out of the illuminating device 3601 even in a case where the laser light is deviated from the defined beam path.

Other advantages of the twentieth embodiment are similar to those of the above-described sixteenth embodiment.

The fourteenth to twentieth embodiments disclosed above are to be considered in all respects as illustrative and not restrictive. The scope of the present invention is set out in the appended claims and not in the descriptions of the embodiments hereinabove, and includes any variations and modifications within the sense and scope equivalent to those of the claims.

For example, the foregoing descriptions of the fourteenth to twentieth embodiments have dealt with examples where illuminating devices of the present invention are applied to automobile headlamps, but this is not meant to limit the present invention. The illuminating devices of the present invention may be applied to headlamps of other moving bodies such as airplanes, ships, robots, motorcycles, bicycles, etc.

The foregoing descriptions of the fourteenth to twentieth embodiments each have dealt with an example where the illuminating devices of the present invention are applied to headlamps, but this is not meant to limit the present invention. The illuminating devices of the present invention may be applied to down lights, spot lights, and other illuminating devices. Further, the illuminating devices of the present invention may be applied to illuminating devices having no reflection member such as electric light bulb-type illuminating devices.

The foregoing descriptions of the fourteenth to twentieth embodiments have dealt with examples where the excitation light is converted to visible light, but this is not meant to limit the present invention, and the excitation light may be converted to light other than visible light. For example, in a case where the excitation light is converted to infrared light, the illuminating devices of the present invention are also applicable to nighttime illuminating devices of CCD cameras for security monitoring and the like.

Further, the foregoing descriptions of the fourteenth to twentieth embodiments have dealt with examples where the excitation light source and the fluorescent member are configured such that white light is emitted, but this is not meant to limit the present invention. The excitation light source and the fluorescent member may be configured such that light of a color other than white is emitted.

Further, the foregoing descriptions of the fourteenth to twentieth embodiments have dealt with examples where a semiconductor laser element is used as the excitation light source that emits laser light, but this is not meant to limit the present invention, and an excitation light source other than a semiconductor laser element may be used.

Further, the foregoing descriptions of the fourteenth to twentieth embodiments have dealt with examples where the reflection surface of the reflection member includes a part of a paraboloid, but this is not meant to limit the present invention, and the reflection surface may include, for example, a part of an ellipsoid. In this case, by positioning the irradiated area of the fluorescent member at the focal point of the reflection surface, it is possible to easily collect light emitted from the illuminating device. Alternatively, the reflection surface may be a multi-reflecting surface composed of a large number of curved surfaces (for example, paraboloids), or a freely-curved reflecting surface composed of a large number of minute flat surfaces that are continuously arranged.

Further, for example, the foregoing descriptions of the sixteenth, seventeenth, and twentieth embodiments have dealt with examples where the inlet 3207b is provided with the transmissive member 3214, but this is not meant to limit the present invention, and the inlet 3207b may be without the transmissive member 3214. Besides, if the cover member 3615 is provided like in the above-described twentieth embodiment, even in a case where the transmissive member 3214 is not provided, it is possible to prevent dust or the like from entering the body 3230 through the inlet 3207b.

Further, the foregoing descriptions of the fourteenth to twentieth embodiments have dealt with examples where an optical fiber or a lens is used as the light guide member, but this is not meant to limit the present invention. A reflection mirror, for example, may be used as the light guide member, or, two or more from an optical fiber, a lens, a reflection mirror, and the like may be used in combination. Note that the light guide member is provided as necessary, and it does not need to be provided in a case where the excitation light source 3002 is disposed near the fluorescent member 3005 like, for example, in an illuminating device 3701 of a seventh modified example of the present invention shown in FIG. 31. In the illuminating device 3701, an excitation light source 3002 and a fluorescent member 3005 are disposed inside a body 3230.

Further, the foregoing descriptions of the fourteenth to twentieth embodiments have dealt with examples where the anti-condensation unit is provided with a heater, but this is not meant to limit the present invention. The condensation removing unit may be provided with, for example, a dehumidifier, a blower, etc. instead of the heater. In such a case as well, it is possible to remove condensation.

Further, the foregoing descriptions of the fourteenth to twentieth embodiments each have dealt with an example where the reflection member is provided with an inlet, but this is not meant to limit the present invention. For example, it is also possible to provide the support member 3206 of the sixteenth embodiment with an inlet.

Further, the foregoing descriptions of the fourteenth to twentieth embodiments have dealt with examples where condensation formed on the laser-light-passing surfaces is removed, but this is not meant to limit the present invention. It is also possible to prevent formation itself of condensation on the laser-light-passing surfaces by constantly maintaining the anti-condensation unit in an ON state.

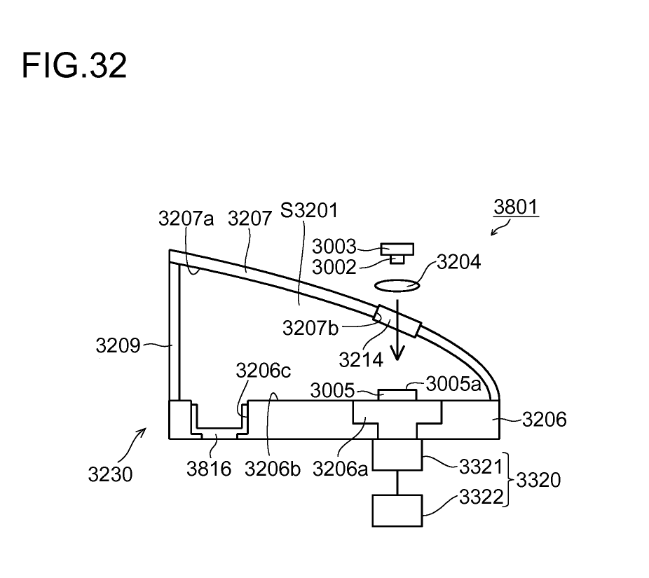

Further, like, for example, an illuminating device 3801 of an eighth modified example of the present invention shown in FIG. 32, there may be provided a getter member 3816 that is made of a highly heat conductive material and disposed remote from the fluorescent member 3005. It is preferable that the getter member 3816 has a heat conductivity that is as high as or higher than that of the holding portion 3206a of the support member 3206. With this configuration, condensation occurs on the getter member 3816 before the holding portion 3206a, and thus, it is possible to reduce condensation on the holding portion 3206a. It is also preferable that the getter member 3816 be disposed in a lower part of the illuminating device 3801. Besides, it is preferable that a recessed portion 3206c be formed in an internal surface 3206b of the support member 3206 to dispose the getter member 3816 inside the recessed portion 3206c. With this configuration, it is possible to reduce dew drops that are formed on a surface of the getter member 3816 to move to other parts. Besides, the getter member 3816 may be exposed to outside the illuminating device 3801. With this configuration, it is possible to easily reduce the temperature of the getter member 3816 before, for example, the temperature of the holding portion 3206a.

Further, surface treatment may be applied to the laser-light-passing surfaces. For example, if a thin film of titanium oxide is provided on a laser-light-passing surface, since titanium oxide is hydrophilic, water droplets formed on the laser-light-passing surface are more likely to spread on and wet the laser-light-passing surface. This helps reduce refraction of laser light in an unintended direction. Alternatively, surface treatment may be applied to the laser-light-passing surfaces such that condensation will be formed as fine water droplets. This construction helps make it easier to evaporate water droplets by means of, for example, a heater.

Further, the foregoing description of the fourteenth embodiment has dealt with an example where the heat conductive layer 3012 is provided on the surface of the light guide member 3004 such that heat generated by the heater 3021 is transferred to the laser-light-exit surface 3004b, but this is not meant to limit the present invention. For example, there may be provided a heat generating portion (such as a resistor) in the vicinity of the laser-light-exit surface 3004b and a wiring layer may be formed on the surface of the light guide member 3004 so as to be connected to the heat generating portion such that power is supplied via the wiring layer to the heat generating portion to thereby allow the heat generating portion to generate heat for removing condensation on the laser-light-exit surface 3004b. In this case, if a coating of, for example, an insulating resin is provided to cover the wiring layer and the heat generating portion, it is possible to easily prevent the wiring layer and the heat generating portion from short-circuiting due to water droplets.

Further, it should be understood that structures obtained by appropriately combining the structures of the foregoing embodiments and modified examples are also included in the scope of the present invention. For example, the fourteenth and fifteenth embodiments may be combined together to remove condensation on both a laser-light-exit surface of a light guide member and an irradiated surface of a fluorescent member. For example, the fourteenth and nineteenth embodiments may be combined together to remove condensation on both a laser-light-exit surface of a light guide member and a reflection surface of a reflection member. In these cases, a single common anti-condensation member may be provided. Besides, for example, the sixteenth and eighteenth embodiments may be combined together to remove condensation on a surface of a transmissive member with heat generated by an excitation light source.

What is claimed is:

1. An illuminating device comprising:
a fluorescent member that is irradiated with laser light functioning as excitation light to emit fluorescence;
a condensation sensor that detects condensation near an optical path of the laser light; and
a controller that limits irradiation of the laser light onto the fluorescent member in a case where the condensation sensor has detected condensation.

2. The illuminating device according to claim 1, wherein the controller controls power of an excitation light source that emits the laser light to be equal to or lower than a predetermined value.

3. The illuminating device according to claim 2, wherein the controller controls the power of the excitation light source to be zero.

4. The illuminating device according to claim 1, wherein the controller blocks or changes the optical path of the laser light.

5. The illuminating device according to claim 4, further comprising a light-blocking member that blocks the optical path of the laser light,
wherein
the controller puts the light-blocking member into the optical path of the laser light.

6. The illuminating device according to claim 1, further comprising a body inside which the fluorescent member is disposed,
wherein
the condensation sensor detects condensation inside the body.

7. The illuminating device according to claim 1, further comprising a condensation removing unit that removes condensation on a laser-light-passing surface of a member disposed in the optical path of the laser light.

8. An illuminating device comprising:
a fluorescent member that is irradiated with laser light functioning as excitation light to emit fluorescence; and
a body constituting a hermetic space inside which the fluorescent member is disposed,
wherein
a dry gas is sealed in the hermetic space, or the hermetic space is a vacuum space.

9. The illuminating device according to claim 8,
wherein
the body includes:
a reflection member that reflects the fluorescence; and
a first transmissive member that transmits the fluorescence and emits the fluorescence to outside the hermetic space.

10. The illuminating device according to claim 8, wherein a dew point inside the hermetic space is equal to or lower than −30° C.

11. The illuminating device according to claim 8,
wherein
an excitation light source that emits laser light functioning as excitation light is disposed outside the hermetic space; and
the body is provided with an inlet for allowing the laser light emitted from the excitation light source into the hermetic space.

12. The illuminating device according to claim 11, wherein an optical path of the laser light from the excitation light source to the inlet is sealed.

13. The illuminating device according to claim 8, wherein the excitation light source that emits laser light functioning as excitation light is disposed inside the hermetic space.

14. An illuminating device comprising:
a fluorescent member that is irradiated with laser light functioning as excitation light to emit fluorescence; and
a first anti-condensation unit that performs a preliminary operation of removing or preventing condensation on a laser-light-passing surface of a member disposed in an optical path of the laser light, the preliminary operation being performed before a principal operation of an excitation light source.

15. The illuminating device according to claim 14, further comprising a light guide member that guides the laser light emitted from the excitation light source to the fluorescent member.

16. The illuminating device according to claim 15,
wherein
the preliminary operation of the first anti-condensation unit comprises removing or preventing condensation on a laser-light-passing surface of the light guide member.

17. The illuminating device according to claim 16,
wherein
the first anti-condensation unit includes a heater for heating the laser-light-passing surface;
the laser-light-passing surface includes a laser-light-exit surface of the light guide member; and
a heat conductive portion that transfers heat generated by the heater to the laser-light-exit surface of the light guide member is provided on a surface of the light guide member.

18. The illuminating device according to claim 17, wherein the heater continues the preliminary operation until a temperature around the laser-light-passing surface reaches a predetermined temperature.

19. The illuminating device according to claim 17,
wherein
the heater continues the preliminary operation until a temperature around the laser-light-passing surface reaches a temperature that is higher than an outside air temperature by a predetermined value.

20. The illuminating device according to claim 14,
wherein
the illuminating device is used as a vehicle headlamp; and
the preliminary operation of the first anti-condensation unit is started in association with at least one of the following: door locking, door unlocking, and door opening/closing.
